(19) United States
(12) Patent Application Publication
(10) Pub. No.: US 2023/0393710 A1
(43) Pub. Date: Dec. 7, 2023

(54) Devices, Methods, and Graphical User Interfaces for Collaborating in a Shared Web Browsing Environment

(71) Applicant: Apple Inc., Cupertino, CA (US)

(72) Inventors: Charles D. Deets, San Jose, CA (US); Marco Triverio, San Francisco, CA (US)

(21) Appl. No.: 18/204,348

(22) Filed: May 31, 2023

Related U.S. Application Data
(60) Provisional application No. 63/348,926, filed on Jun. 3, 2022.

(51) Int. Cl. G06F 3/0483; H04L 51/18; G06F 3/04817; G06F 3/0482

(52) U.S. Cl. CPC G06F 3/0483; H04L 51/18; G06F 3/04817; G06F 3/0482

(57) ABSTRACT

In one example method, a shared web-browser method is performed at a first electronic device with a display generation component. In this example, the first electronic device is associated with a first user account, and is also in communication with a second electronic device that is associated with a second user account. The method comprises displaying, via the display generation component, a web-browser user interface including one or more tabs shared with the second electronic device. Each tab of the one or more tabs is associated with a respective webpage. The method also includes, receiving, at the first electronic device, information indicating that a tab group comprising one or more tabs has been interacted with at the second electronic device associated with the second user account. The method further comprises, indicating, at the first electronic device, that the tab group has been interacted with at the second electronic device.

### RELATED APPLICATIONS

This application claims priority to U.S. Provisional Patent Application No. 63/348,926, filed Jun. 3, 2022, which is hereby incorporated by reference in its entirety.

### TECHNICAL FIELD

This disclosure relates generally to displaying user interfaces on electronic devices for a collaborative shared web-browsing experience, where an input within a web-browser application of a first device causes a change at both the first device and in a web-browser application of a second device remote from the first device. In some embodiments, the first device and second device are associated with different users (e.g., having distinct and unique user accounts).

### BACKGROUND

The need to share webpages between users of electronic devices has grown significantly in recent years. Example sharing techniques include sharing copied links (e.g., URLs), via messaging applications, to other contacts (e.g., using different devices) or sending screenshots between devices. These approaches, however, have many inefficiencies, such as losing track of shared links in messaging conversations (e.g., needing to scroll through old conversations to find links and related commentary) and losing context as to why a webpage was shared and from whom. These cumbersome and inefficient approaches require more interactions with the electronic device, which wastes a user's time, and increases the use of resources (e.g., battery consumption) of the users' mobile devices.

### SUMMARY

Accordingly, there is a need for efficiently sharing webpages and collaboratively interacting with shared webpages (e.g., when users are sharing webpages, selecting a link on one device causes the same link to be opened on another device). Sharing additional webpages while remaining in the web-browser application reduces the need to switch between applications (e.g., switching from a web-browser, to a messaging application, and back to the web-browser) in order to interact with and/or share shared webpages. These collaborative web-browsing user interfaces reduce the number, extent, and/or nature of the inputs from a user and produce a more efficient human-machine interface. For battery-operated devices, such methods and interfaces conserve power and increase the time between battery charges.

The above deficiencies and other problems associated with user interfaces for electronic devices with touch-sensitive surfaces are reduced or eliminated by the disclosed devices. In some embodiments, the device is a desktop computer. In some embodiments, the device is portable (e.g., a notebook computer, tablet computer, or handheld device). In some embodiments, the device is a personal electronic device (e.g., a wearable electronic device, such as a watch). In some embodiments, the device has a touchpad. In some embodiments, the device has a touch-sensitive display (also known as a “touch screen” or “touch-screen display”). In some embodiments, the device has a graphical user interface (GUI), one or more processors, memory and one or more modules, programs or sets of instructions stored in the memory for performing multiple functions. In some embodiments, the user interacts with the GUI primarily through stylus and/or finger contacts and gestures on the touch-sensitive surface. In some embodiments, the functions optionally include image editing, drawing, presenting, word processing, spreadsheet making, game playing, telephoning, video conferencing, e-mailing, instant messaging, workout support, digital photographing, digital videoing, web browsing, digital music playing, note taking, and/or digital video playing. Executable instructions for performing these functions are, optionally, included in a non-transitory computer readable storage medium or other computer program product configured for execution by one or more processors.

In accordance with some embodiments, a shared web-browser method is performed at a first electronic device with a display generation component. In some embodiments, the first electronic device is associated with a first user account. In some embodiments, the first user device is in communication with a second electronic device associated with a second user account. In some embodiments, the first electronic device displays, via the display generation component, a web-browser user interface including one or more tabs shared with the second electronic device. In some embodiments, each tab of the one or more tabs is associated with a respective webpage. In some embodiments, the first electronic device receives information indicating that a tab group comprising one or more tabs has been interacted with at the second electronic device associated with the second user account, and the first electronic device indicates that the tab group has been interacted with at the second electronic device.

In accordance with some embodiments, an electronic device includes a display, a touch-sensitive surface, optionally one or more sensors to detect intensities of contacts with the touch-sensitive surface, optionally one or more tactile output generators, one or more processors, and memory storing one or more programs; the one or more programs are configured to be executed by the one or more processors and the one or more programs include instructions for performing or causing performance of the operations of any of the methods described herein. In accordance with some embodiments, a computer readable storage medium has stored therein instructions that, when executed by an electronic device with a display, a touch-sensitive surface, optionally one or more sensors to detect intensities of contacts with the touch-sensitive surface, and optionally one or more tactile output generators, cause the device to perform or cause performance of the operations of any of the methods described herein. In accordance with some embodiments, a graphical user interface on an electronic device with a display, a touch-sensitive surface, optionally one or more sensors to detect intensities of contacts with the touch-sensitive surface, optionally one or more tactile output generators, a memory, and one or more processors to execute one or more programs stored in the memory includes one or more of the elements displayed in any of the methods described herein, which are updated in response to inputs, as described in any of the methods described herein. In accordance with some embodiments, an electronic device includes: a display, a touch-sensitive surface, optionally one or more sensors to detect intensities of contacts with the touch-sensitive surface, and optionally one or more tactile output generators; and means for performing or causing performance of the operations of any of the methods described herein. In accordance with some embodiments, an information processing apparatus, for use in an electronic device with a display, a touch-sensitive surface, optionally one or more sensors to detect intensities of contacts with the touch-sensitive surface, and optionally one or more tactile output generators, includes means for performing or causing performance of the operations of any of the methods described herein.

Thus, electronic devices with displays, touch-sensitive surfaces, optionally one or more sensors to detect intensities of contacts with the touch-sensitive surface, optionally one or more tactile output generators, optionally one or more device orientation sensors, and optionally an audio system, are provided with improved methods and interfaces for a shared web-browser environment, thereby increasing the effectiveness, efficiency, and user satisfaction with such devices. Such methods and interfaces may complement or replace conventional methods for sharing webpages.

### BRIEF DESCRIPTION OF THE DRAWINGS

For a better understanding of the various described embodiments, reference should be made to the Description of Embodiments below, in conjunction with the following drawings in which like reference numerals refer to corresponding parts throughout the figures.

FIG. 1A is a block diagram illustrating a portable multifunction device with a touch-sensitive display in accordance with some embodiments.

FIG. 1B is a block diagram illustrating example components for event handling in accordance with some embodiments.

FIG. 2 illustrates a portable multifunction device having a touch screen in accordance with some embodiments.

FIG. 3 is a block diagram of an example multifunction device with a display and a touch-sensitive surface in accordance with some embodiments.

FIG. 4A illustrates an example user interface for a menu of applications on a portable multifunction device in accordance with some embodiments.

FIG. 4B illustrates an example user interface for a multifunction device with a touch-sensitive surface that is separate from the display in accordance with some embodiments.

FIGS. 5A-5S illustrate how user interfaces associated with a collaborative shared web-browsing session are updated based on interactions occurring at one device and another device, where each device is associated with its own respective user account, in accordance with some embodiments.

FIGS. 6A-6D are flow charts illustrating a collaborative shared web-browsing method 600, in accordance with some embodiments.

### DESCRIPTION OF EMBODIMENTS

Many electronic devices share webpages by copying and sending links via messaging applications. However, such an approach is inefficient as it requires users to switch applications and navigate chat histories to find shared links. Thus, there is a need to share webpages within web-browser applications (also referred to herein as a browser) while also allowing users to collaborate on webpages. In other words, users can make a change on their device (e.g., clicking a link to a new webpage from a shared webpage) and have their change propagated to all other devices in a shared group. These changes can be made by any member of the group, meaning that each member of the shared tab group has the ability to interact with shared webpages, open new webpages, close shared webpages, etc. within the shared group. To avoid this being jarring to other members of the shared group, and in situations where context is needed, updates are provided to members of the shared group to inform them when changes have occurred (e.g., when a new webpage is opened within the group). This is particularly important when a user has not viewed the shared webpages recently. To further enhance the experience, favorites may be associated with the shared tab group; browsing history related to the shared tab group will be accessible by all members; and visual indicators will show when something has changed (e.g., a new tab or updated tab can display a dot on it). It is also noted that multiple shared tab groups can be created and each one of those tab groups can be shared with the same or different members (e.g., the same members may have a tab group for an upcoming group trip and a different tab group for sharing recipes).

In some embodiments, the methods, devices, and GUIs described herein use haptic feedback to improve user interface interactions in multiple ways. For example, they make it easier to share content, interact with shared content, and keep track of shared webpages.

The processes described below enhance the operability of the devices and make the user-device interfaces more efficient (e.g., by helping the user to provide proper inputs and reducing user mistakes when operating/interacting with the device) through various techniques, including by providing improved visual, audio, and/or tactile feedback to the user, reducing the number of inputs needed to perform an operation, providing additional control options without cluttering the user interface with additional displayed controls, performing an operation when a set of conditions has been met without requiring further user input, and/or additional techniques. These techniques also reduce power usage and improve battery life of the device by enabling the user to use the device more quickly and efficiently.

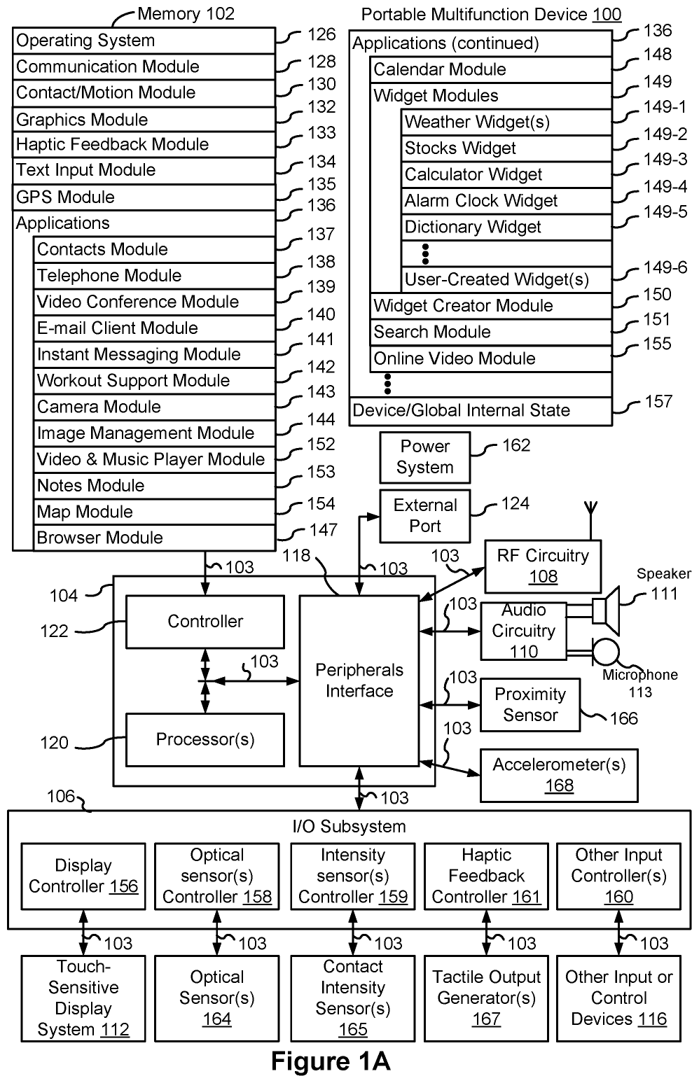

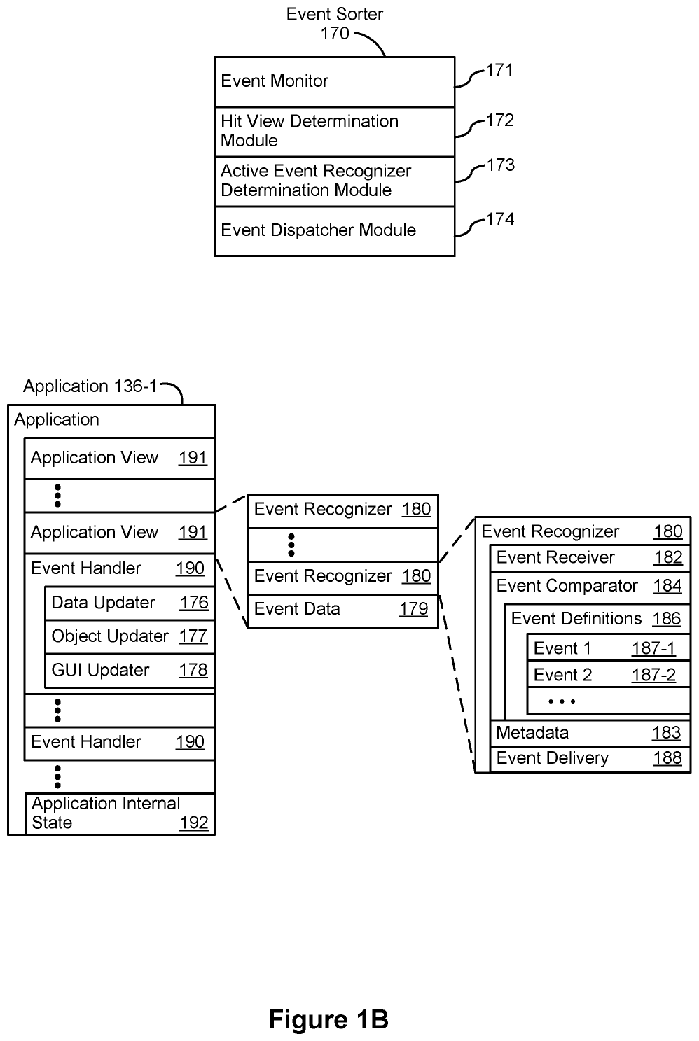

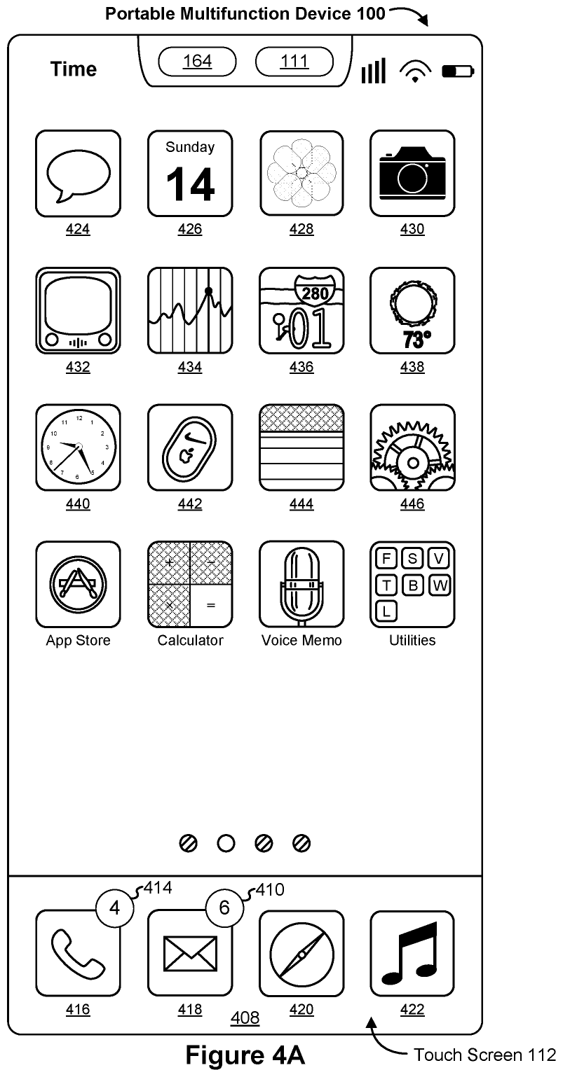

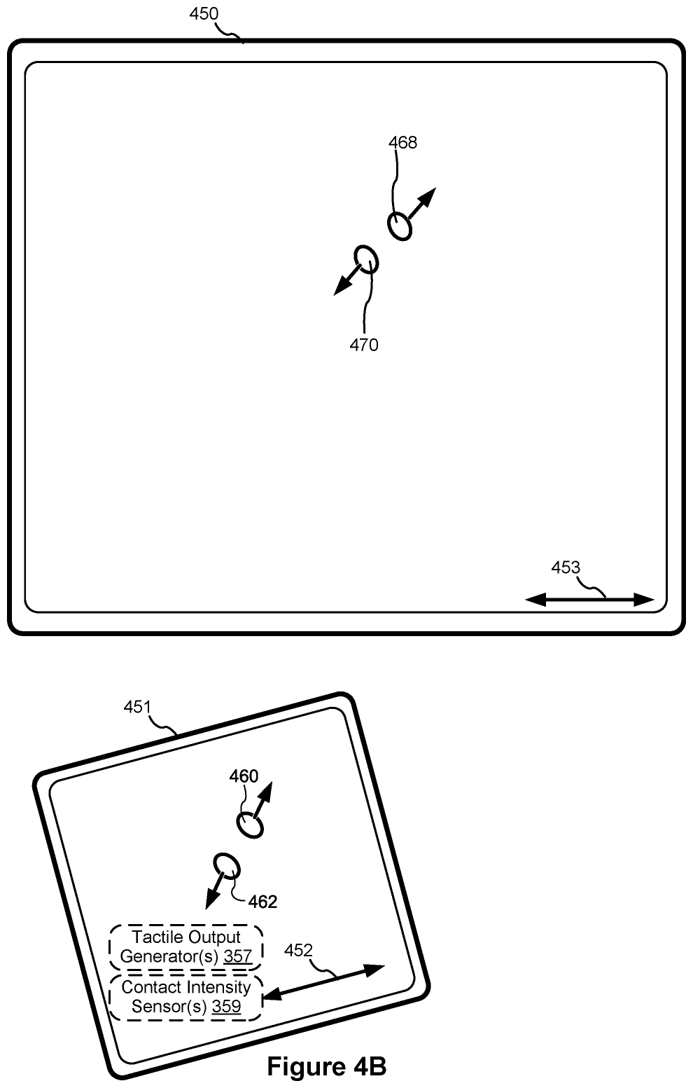

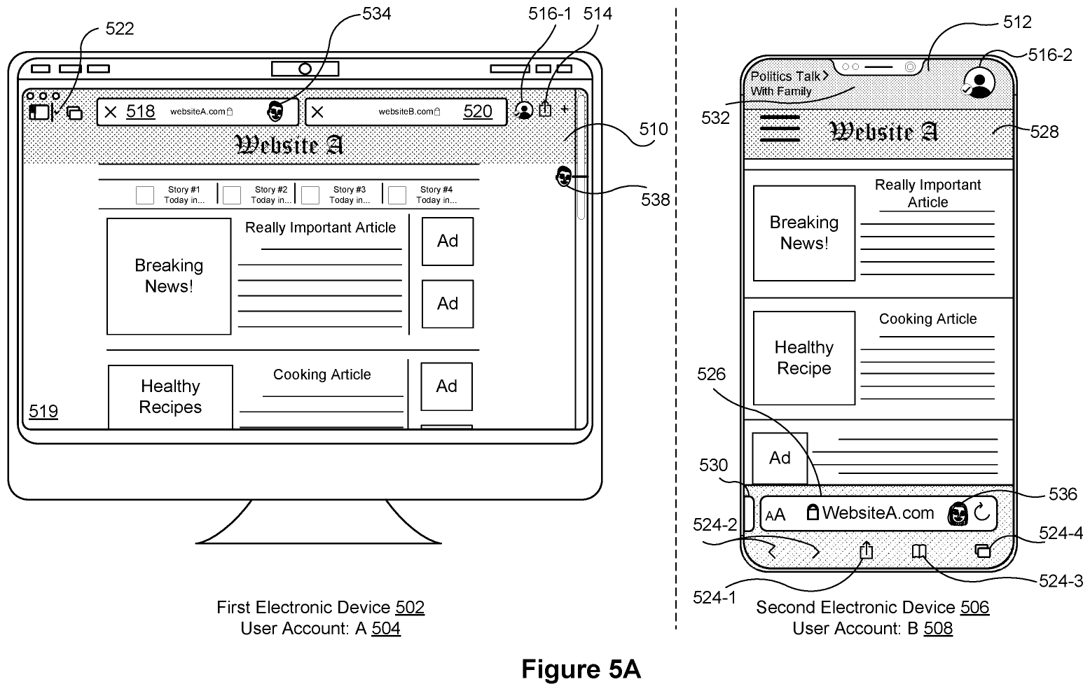

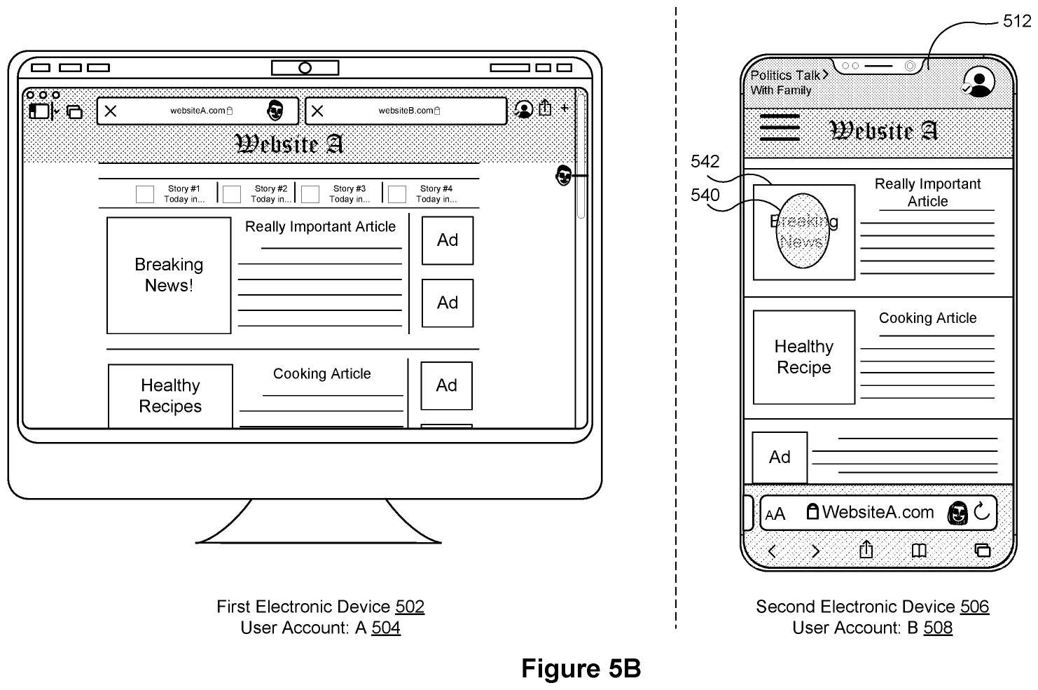

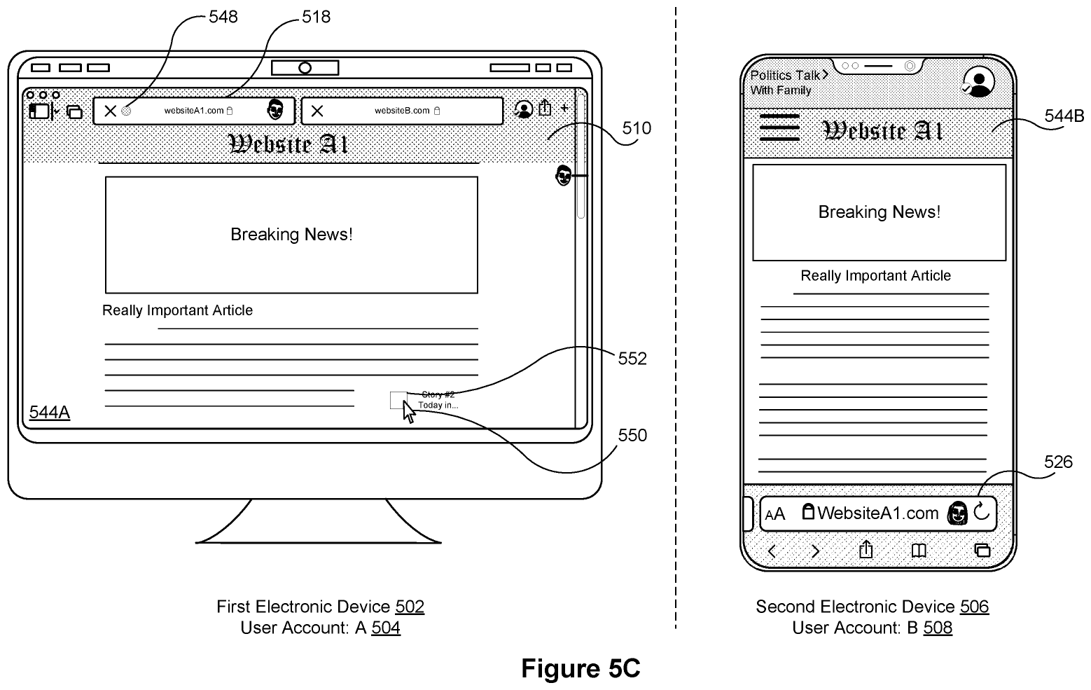

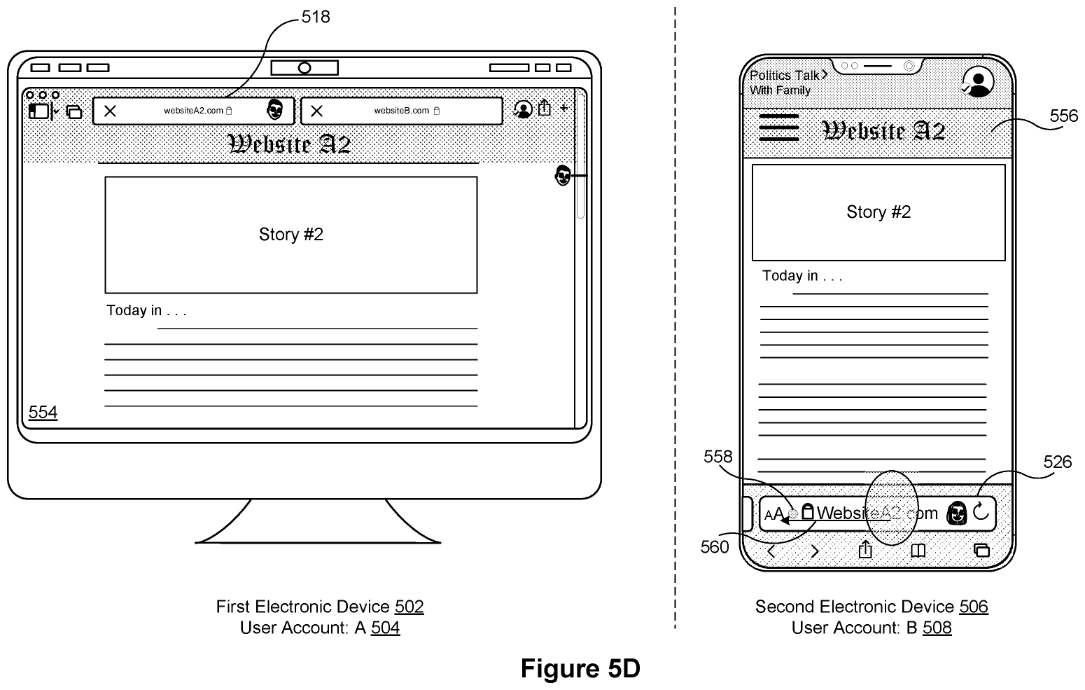

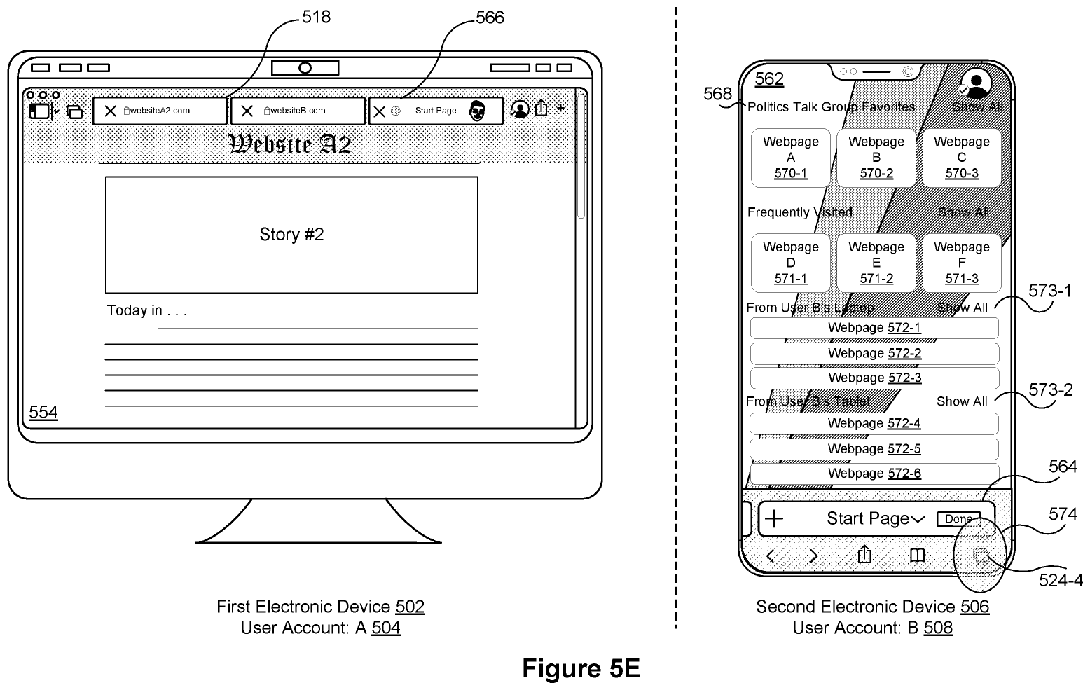

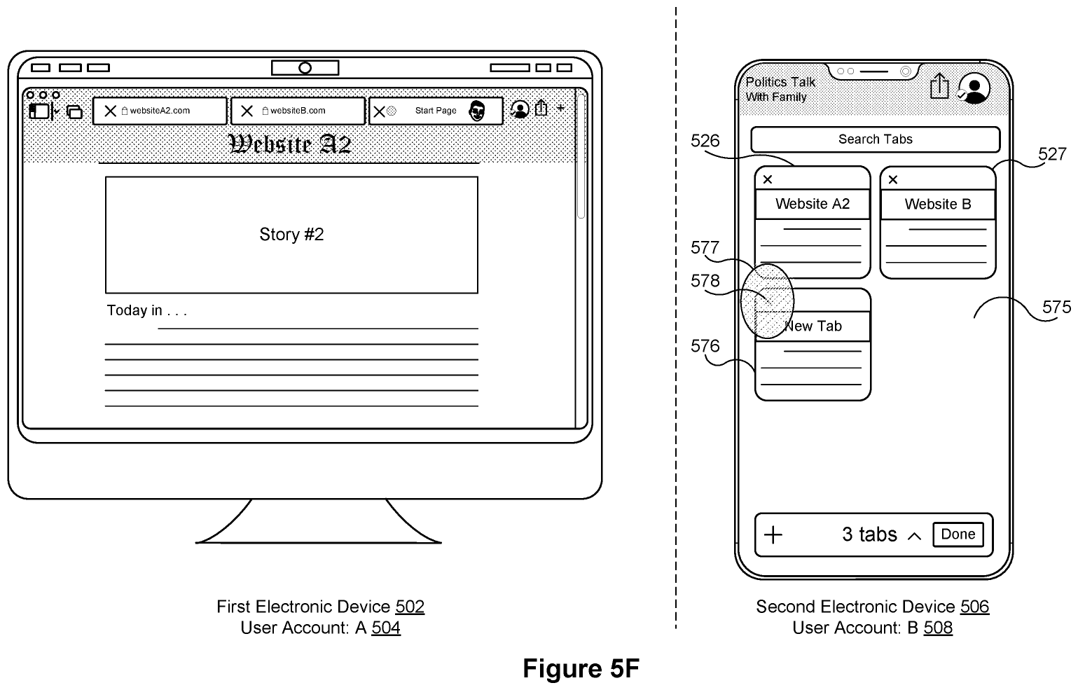

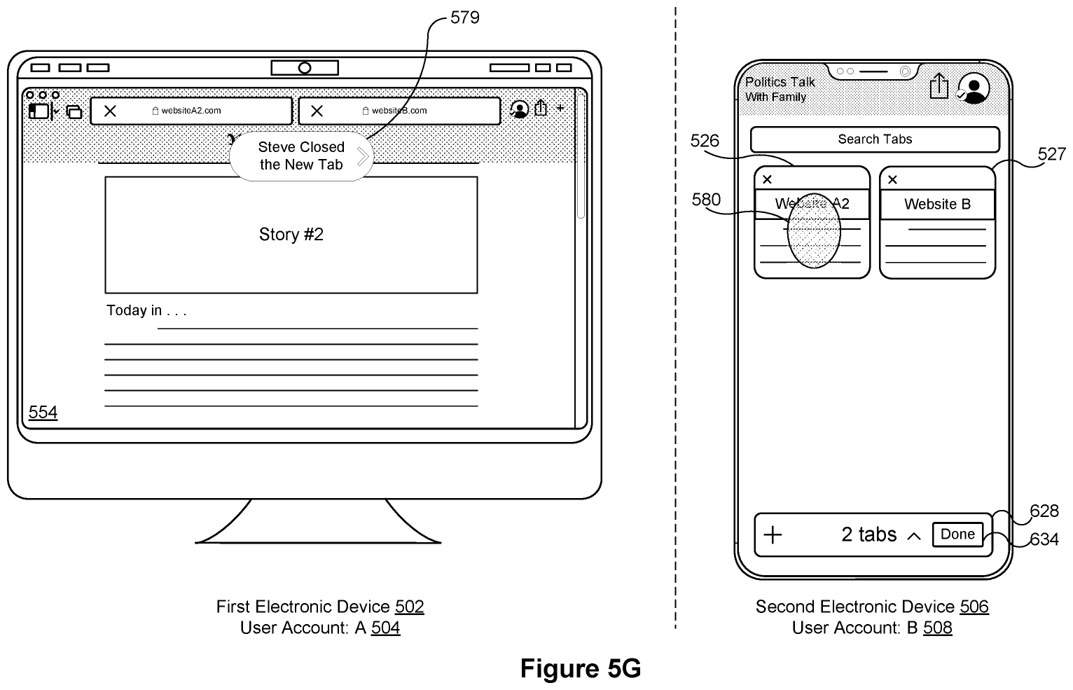

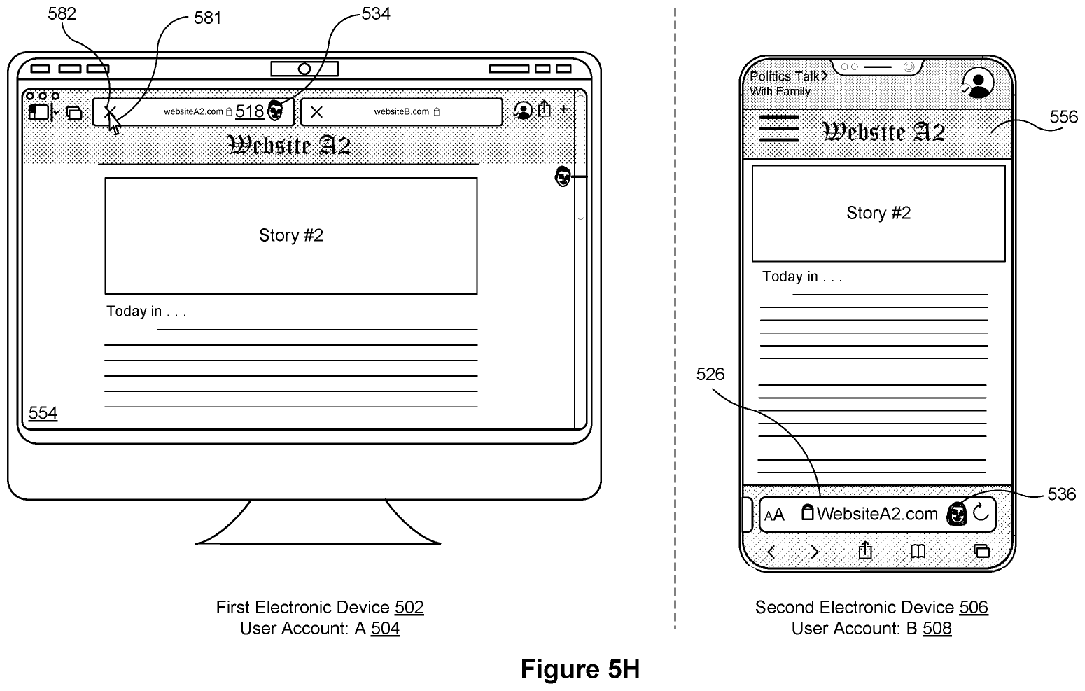

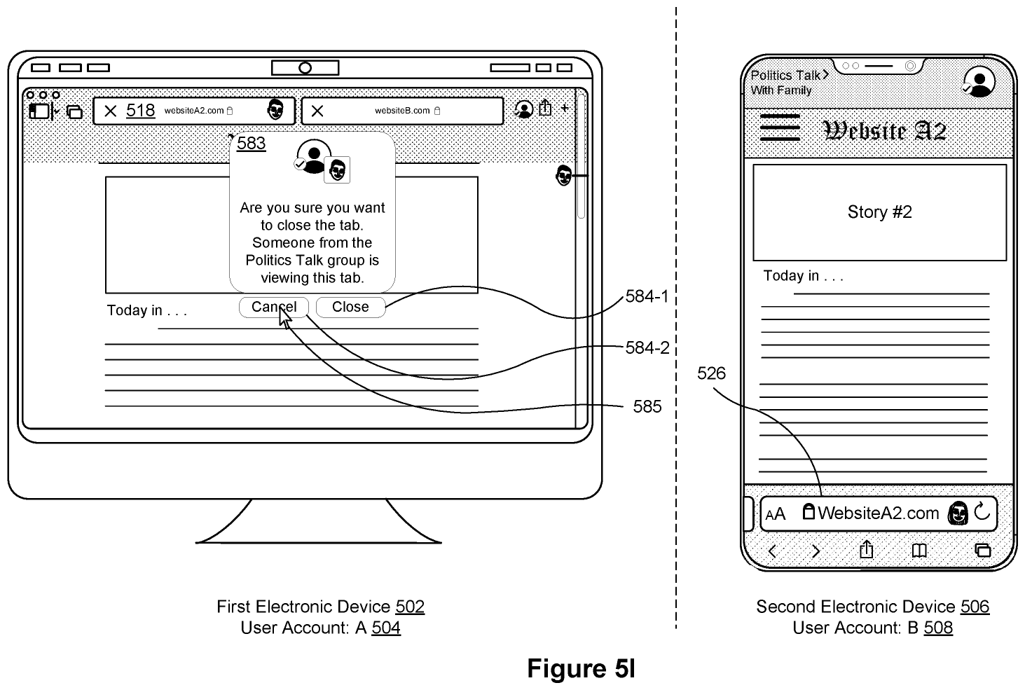

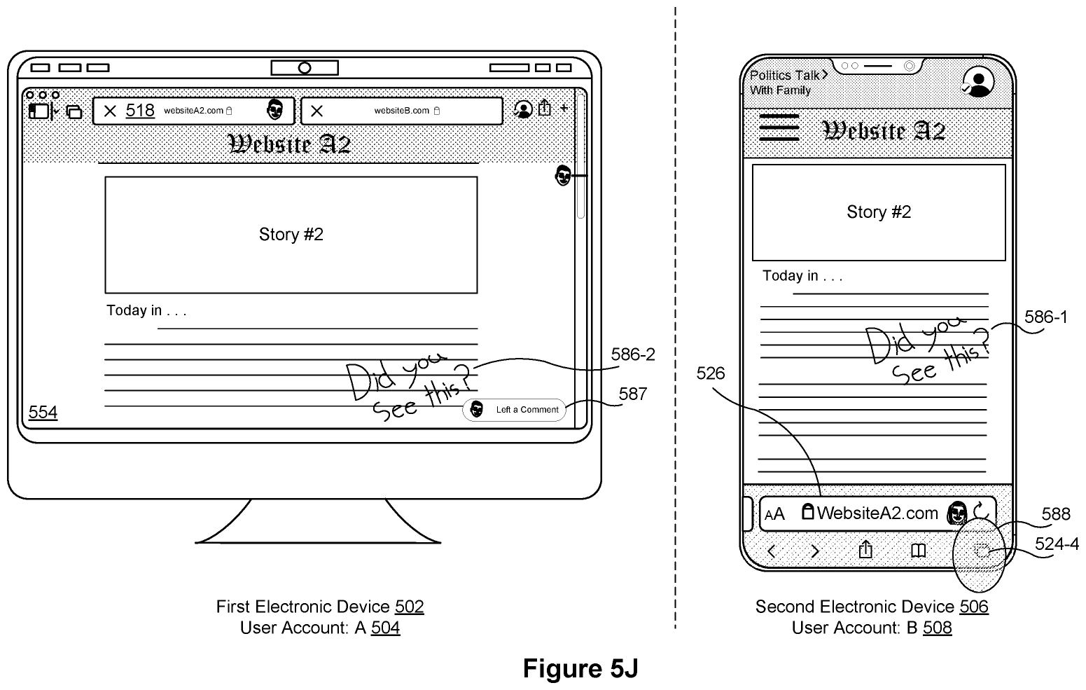

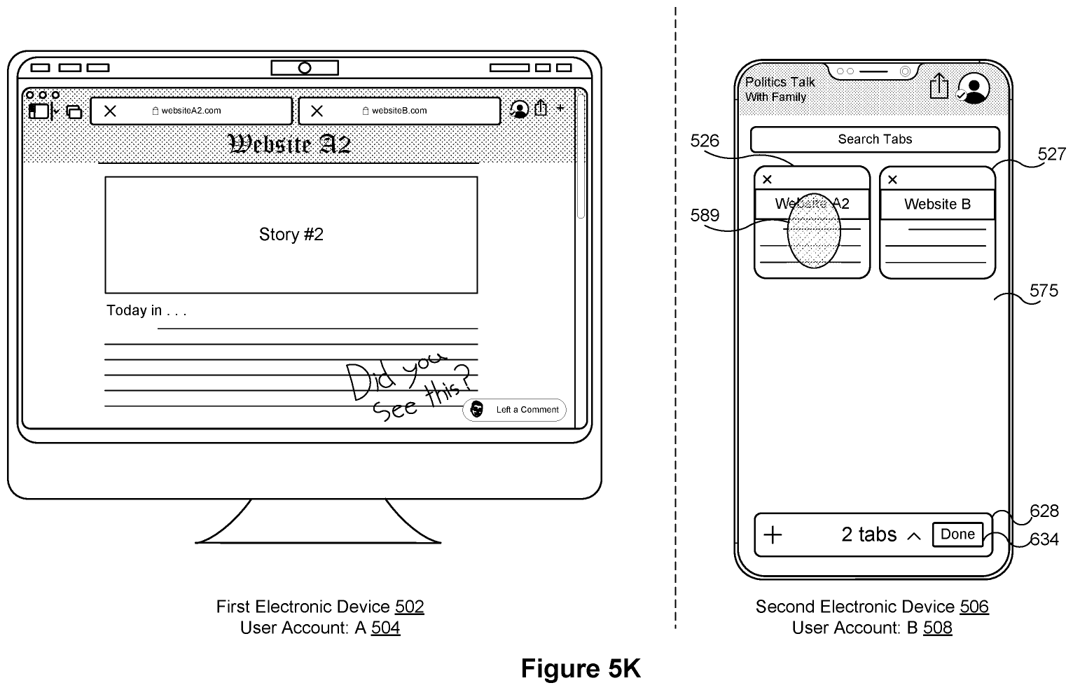

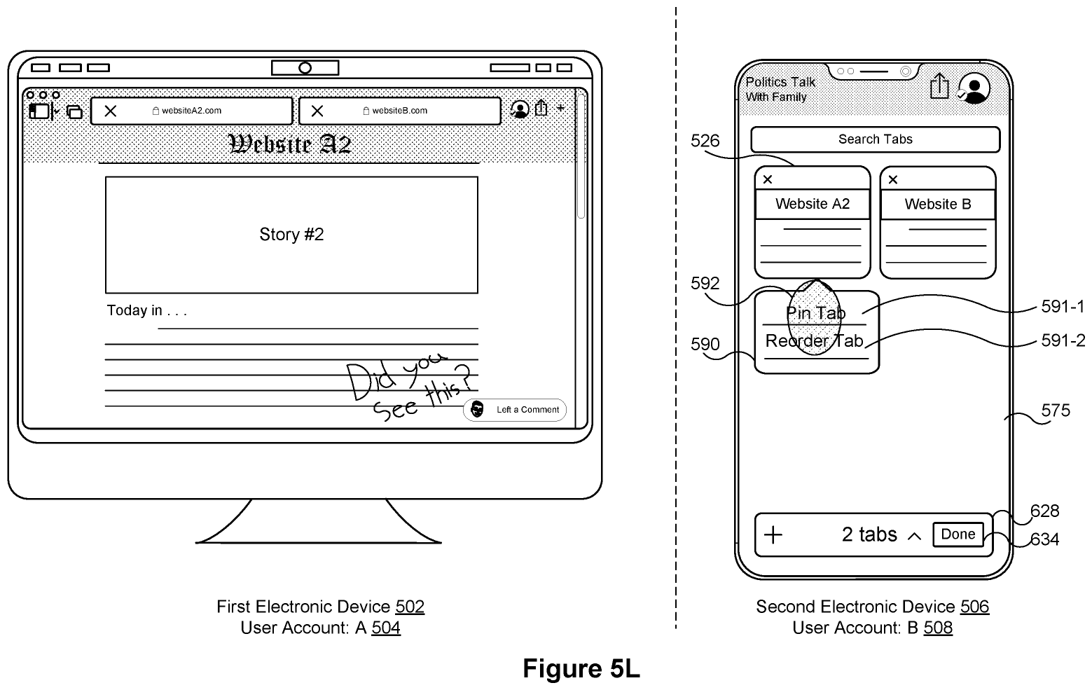

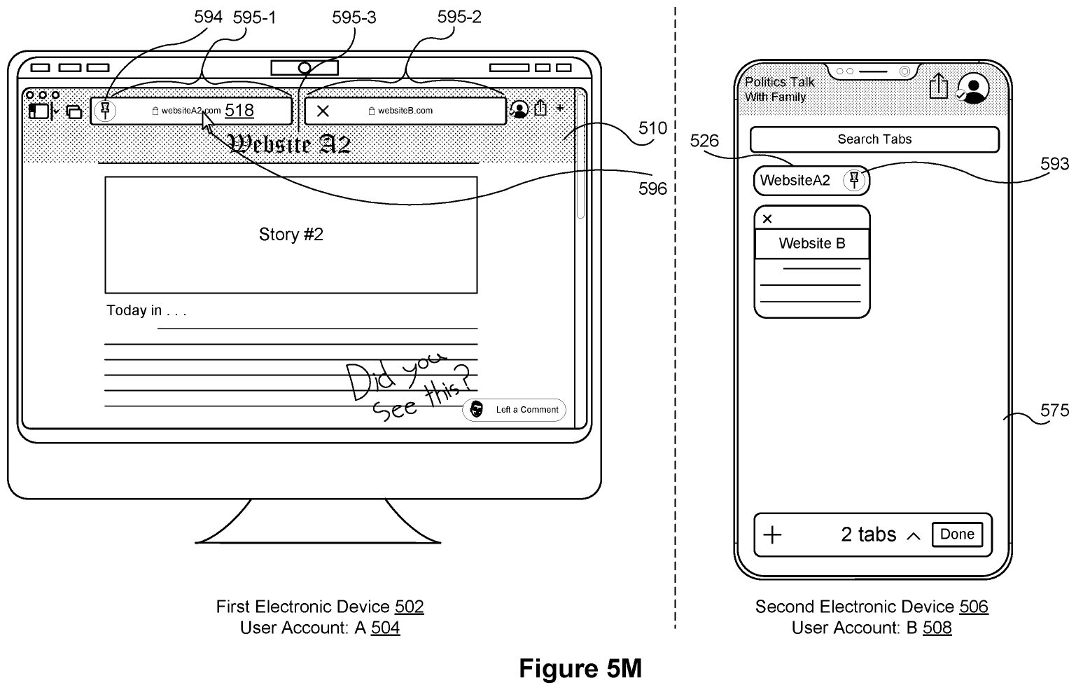

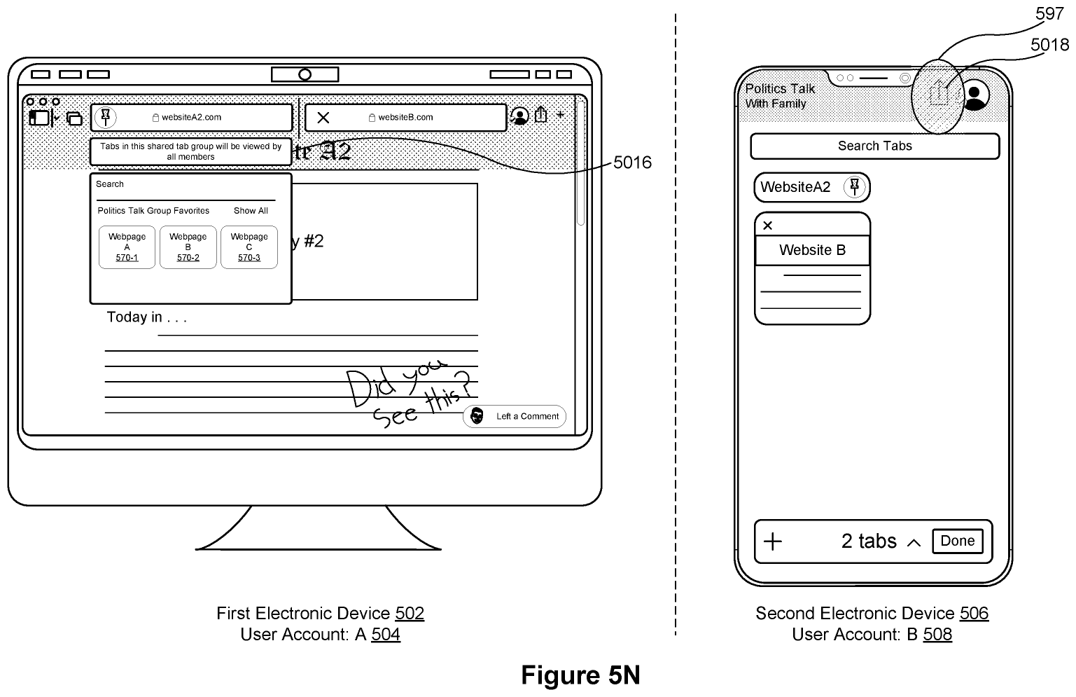

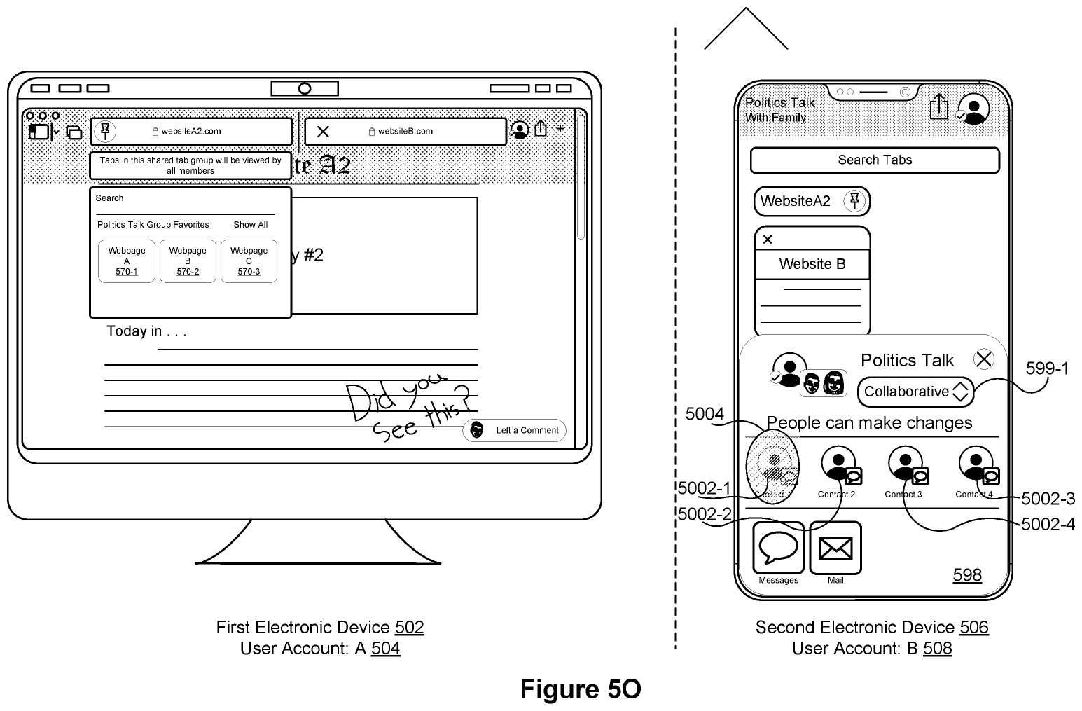

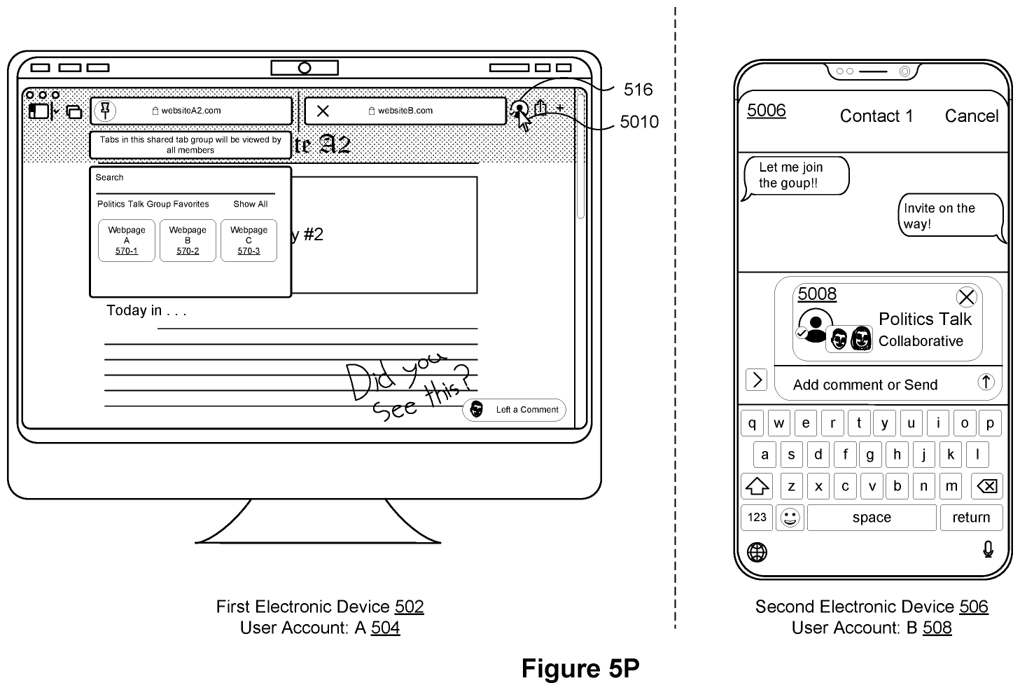

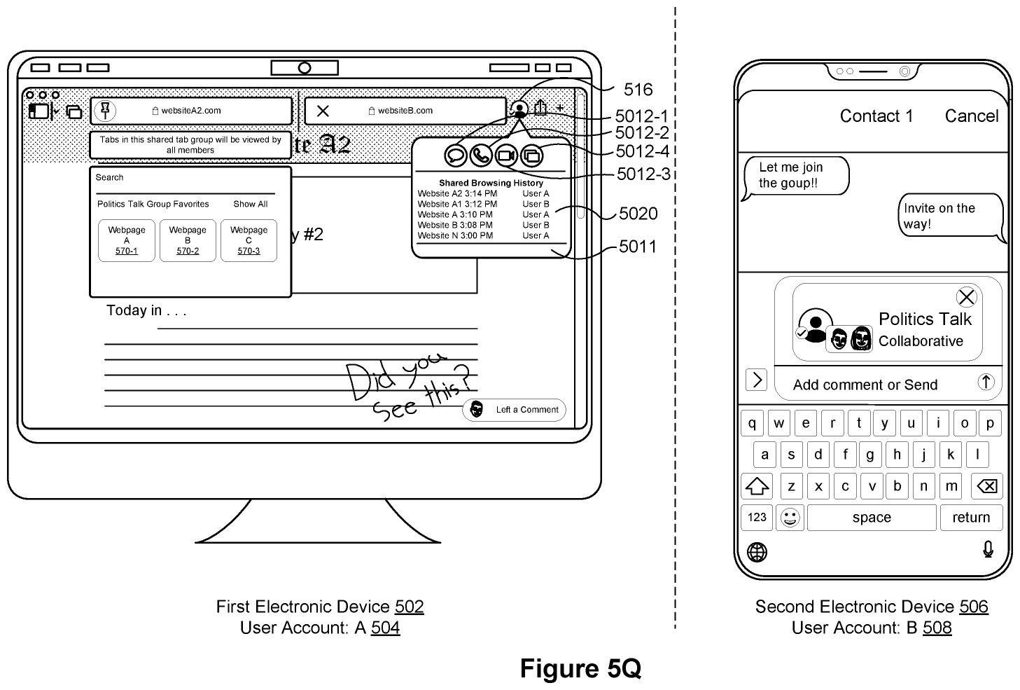

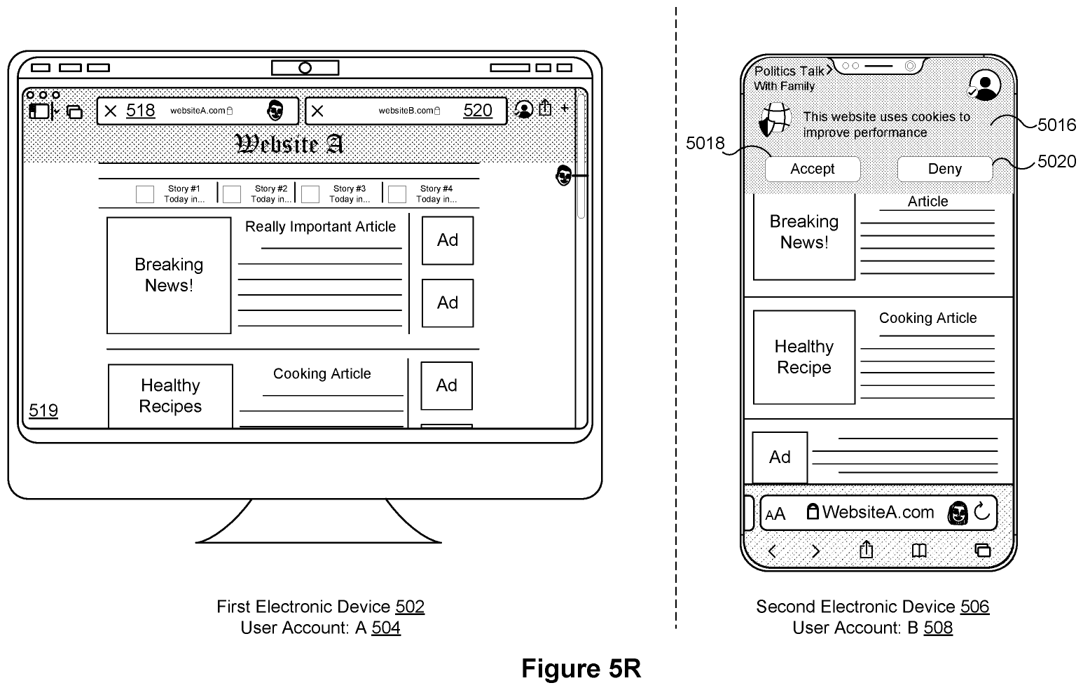

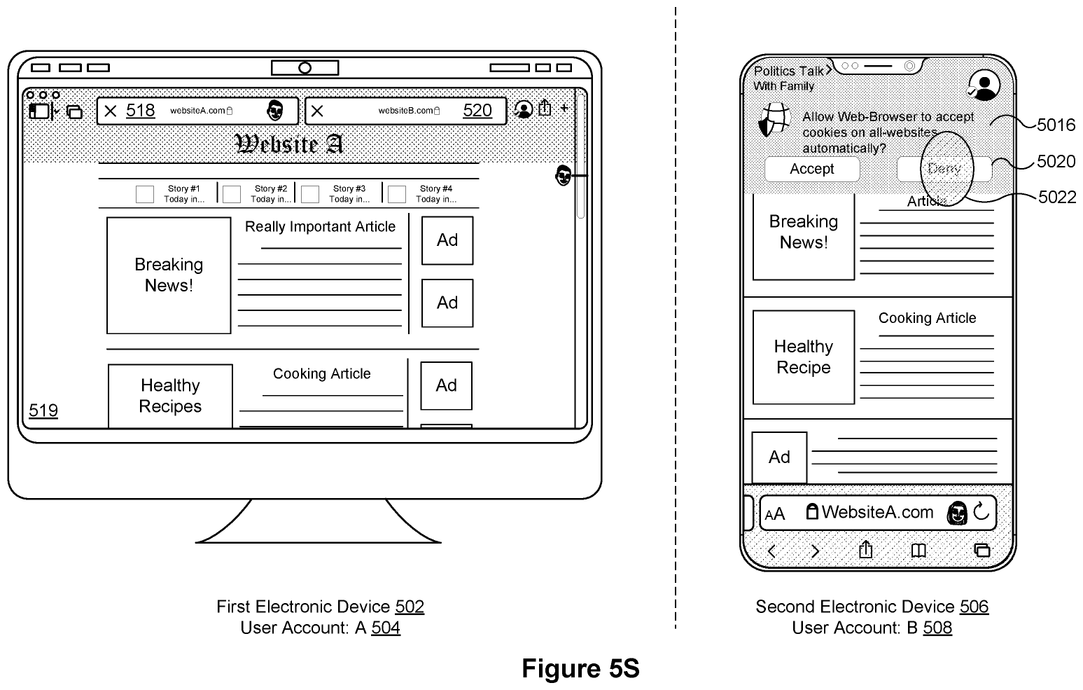

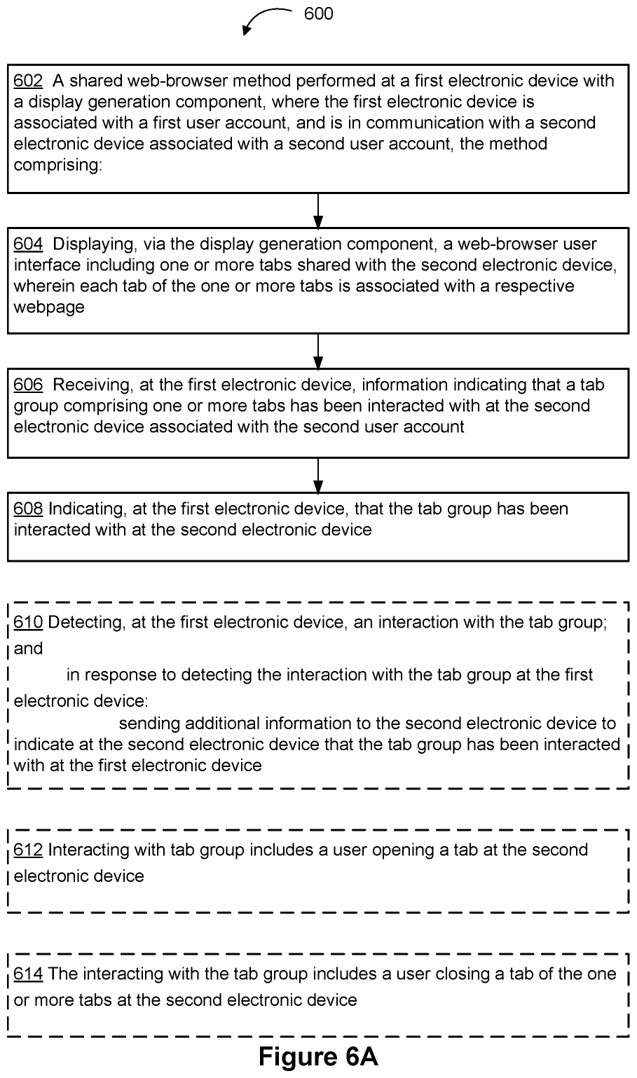

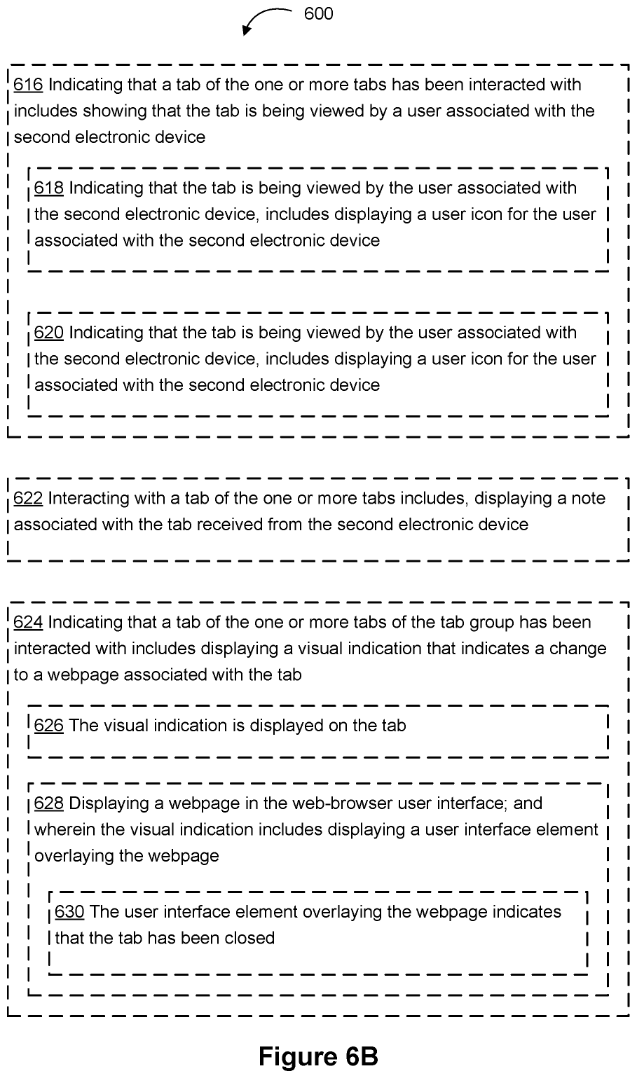

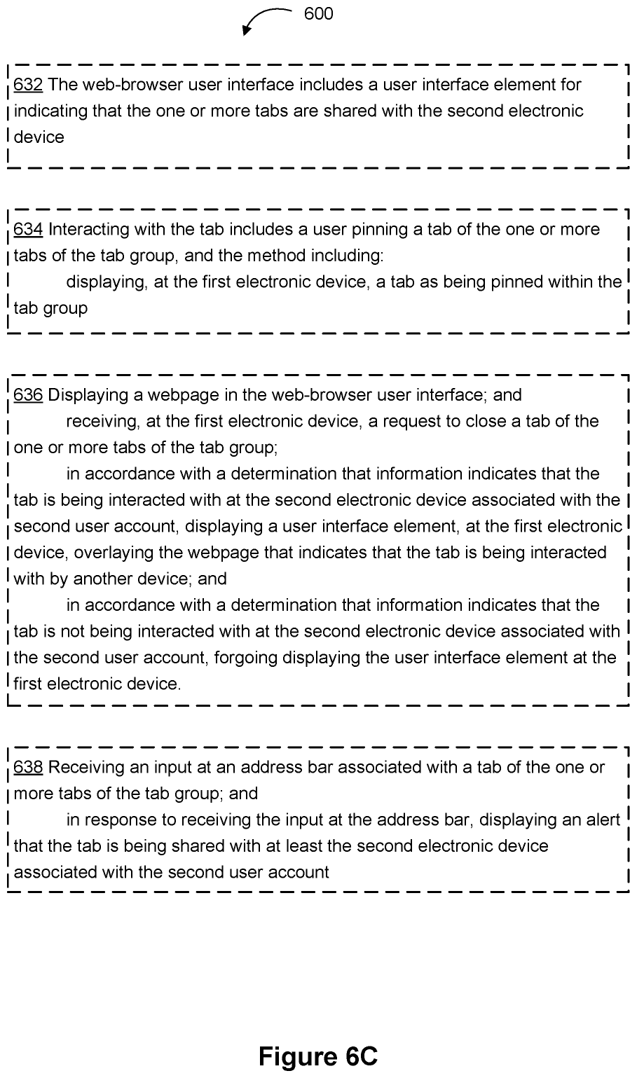

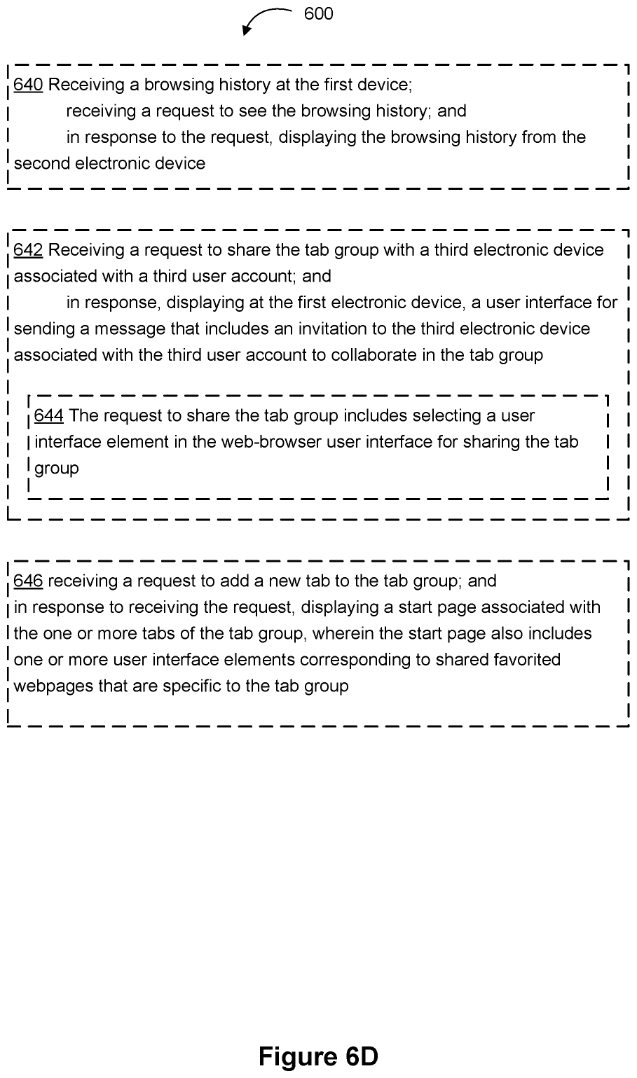

Below, FIGS. 1A-1B, 2, and 3 provide a description of example devices. FIGS. 4A-4B and 5A-5S illustrate example user interfaces for a collaborative shared web-browsing environment. FIGS. 6A-6D illustrate a flow diagram of a interactions occurring in a shared web-browser environment. The user interfaces in FIGS. 5A-5S are used to illustrate the processes in FIGS. 6A-6D.

### Example Devices

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact, unless the context clearly indicates otherwise.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Embodiments of electronic devices, user interfaces for such devices, and associated processes for using such devices are described. In some embodiments, the device is a portable communications device, such as a mobile telephone, that also contains other functions, such as PDA and/or music player functions. Example embodiments of portable multifunction devices include, without limitation, the iPhone®, iPod Touch®, and iPad® devices from Apple Inc. of Cupertino, California. Other portable electronic devices, such as laptops or tablet computers with touch-sensitive surfaces (e.g., touch-screen displays and/or touchpads), are, optionally, used. It should also be understood that, in some embodiments, the device is not a portable communications device, but is a desktop computer with a touch-sensitive surface (e.g., a touch-screen display and/or a touchpad).

In the discussion that follows, an electronic device that includes a display and a touch-sensitive surface is described. It should be understood, however, that the electronic device optionally includes one or more other physical user-interface devices, such as a physical keyboard, a mouse and/or a joystick.

The device typically supports a variety of applications, such as one or more of the following: a note taking application, a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

Attention is now directed toward embodiments of portable devices with touch-sensitive displays. FIG. 1A is a block diagram illustrating portable multifunction device 100 with touch-sensitive display system 112 in accordance with some embodiments. Touch-sensitive display system 112 is sometimes called a “touch screen” for convenience, and is sometimes simply called a touch-sensitive display. Device 100 includes memory 102 (which optionally includes one or more computer readable storage mediums), memory controller 122, one or more processing units (CPUs) 120, peripherals interface 118, RF circuitry 108, audio circuitry 110, speaker 111, microphone 113, input/output (I/O) subsystem 106, other input or control devices 116, and external port 124. Device 100 optionally includes one or more optical sensors 164. Device 100 optionally includes one or more intensity sensors 165 for detecting intensities of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user. Using tactile outputs to provide haptic feedback to a user enhances the operability of the device and makes the user-device interface more efficient (e.g., by helping the user to provide proper inputs and reducing user mistakes when operating/interacting with the device) which, additionally, reduces power usage and improves battery life of the device by enabling the user to use the device more quickly and efficiently.

In some embodiments, a tactile output pattern specifies characteristics of a tactile output, such as the amplitude of the tactile output, the shape of a movement waveform of the tactile output, the frequency of the tactile output, and/or the duration of the tactile output.

When tactile outputs with different tactile output patterns are generated by a device (e.g., via one or more tactile output generators that move a moveable mass to generate tactile outputs), the tactile outputs may invoke different haptic sensations in a user holding or touching the device. While the sensation of the user is based on the user's perception of the tactile output, most users will be able to identify changes in waveform, frequency, and amplitude of tactile outputs generated by the device. Thus, the waveform, frequency and amplitude can be adjusted to indicate to the user that different operations have been performed. As such, tactile outputs with tactile output patterns that are designed, selected, and/or engineered to simulate characteristics (e.g., size, material, weight, stiffness, smoothness, etc.); behaviors (e.g., oscillation, displacement, acceleration, rotation, expansion, etc.); and/or interactions (e.g., collision, adhesion, repulsion, attraction, friction, etc.) of objects in a given environment (e.g., a user interface that includes graphical features and objects, a simulated physical environment with virtual boundaries and virtual objects, a real physical environment with physical boundaries and physical objects, and/or a combination of any of the above) will, in some circumstances, provide helpful feedback to users that reduces input errors and increases the efficiency of the user's operation of the device. Additionally, tactile outputs are, optionally, generated to correspond to feedback that is unrelated to a simulated physical characteristic, such as an input threshold or a selection of an object. Such tactile outputs will, in some circumstances, provide helpful feedback to users that reduces input errors and increases the efficiency of the user's operation of the device.

In some embodiments, a tactile output with a suitable tactile output pattern serves as a cue for the occurrence of an event of interest in a user interface or behind the scenes in a device. Examples of the events of interest include activation of an affordance (e.g., a real or virtual button, or toggle switch) provided on the device or in a user interface, success or failure of a requested operation, reaching or crossing a boundary in a user interface, entry into a new state, switching of input focus between objects, activation of a new mode, reaching or crossing an input threshold, detection or recognition of a type of input or gesture, etc. In some embodiments, tactile outputs are provided to serve as a warning or an alert for an impending event or outcome that would occur unless a redirection or interruption input is timely detected. Tactile outputs are also used in other contexts to enrich the user experience, improve the accessibility of the device to users with visual or motor difficulties or other accessibility needs, and/or improve efficiency and functionality of the user interface and/or the device. Tactile outputs are optionally accompanied with audio outputs and/or visible user interface changes, which further enhance a user's experience when the user interacts with a user interface and/or the device, and facilitate better conveyance of information regarding the state of the user interface and/or the device, and which reduce input errors and increase the efficiency of the user's operation of the device.

It should be appreciated that device 100 is only one example of a portable multifunction device, and that device 100 optionally has more or fewer components than shown, optionally combines two or more components, or optionally has a different configuration or arrangement of the components. The various components shown in FIG. 1A are implemented in hardware, software, firmware, or a combination thereof, including one or more signal processing and/or application specific integrated circuits.

Memory 102 optionally includes high-speed random access memory and optionally also includes non-volatile memory, such as one or more magnetic disk storage devices, flash memory devices, or other non-volatile solid-state memory devices. Access to memory 102 by other components of device 100, such as CPU(s) 120 and the peripherals interface 118, is, optionally, controlled by memory controller 122.

Peripherals interface 118 can be used to couple input and output peripherals of the device to CPU(s) 120 and memory 102. The one or more processors 120 run or execute various software programs and/or sets of instructions stored in memory 102 to perform various functions for device 100 and to process data.

In some embodiments, peripherals interface 118, CPU(s) 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The wireless communication optionally uses any of a plurality of communications standards, protocols and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPA), long term evolution (LTE), near field communication (NFC), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11ac, IEEE 802.11ax, IEEE 802.11b, IEEE 802.11g and/or IEEE 802.11n), voice over Internet Protocol (VoIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

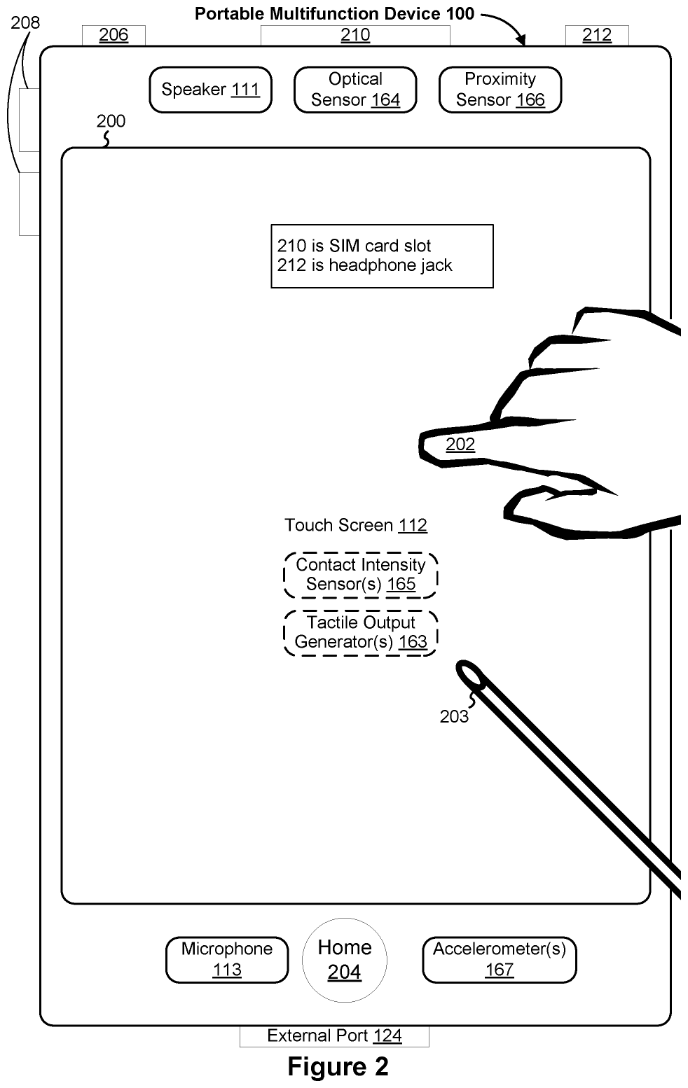

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both ears) and input (e.g., a microphone).

I/O subsystem 106 couples input/output peripherals on device 100, such as touch-sensitive display system 112 and other input or control devices 116, with peripherals interface 118. I/O subsystem 106 optionally includes display controller 156, optical sensor controller 158, intensity sensor controller 159, haptic feedback controller 161, and one or more input controllers 160 for other input or control devices. The one or more input controllers 160 receive/send electrical signals from/to other input or control devices 116. The other input or control devices 116 optionally include physical buttons (e.g., push buttons, rocker buttons, etc.), dials, slider switches, joysticks, click wheels, and so forth. In some alternate embodiments, input controller(s) 160 are, optionally, coupled with any (or none) of the following: a keyboard, infrared port, USB port, stylus, and/or a pointer device such as a mouse. The one or more buttons (e.g., 208, FIG. 2) optionally include an up/down button for volume control of speaker 111 and/or microphone 113. The one or more buttons optionally include a push button (e.g., 206, FIG. 2).

Touch-sensitive display system 112 provides an input interface and an output interface between the device and a user. Display controller 156 receives and/or sends electrical signals from/to touch-sensitive display system 112. Touch-sensitive display system 112 displays visual output to the user. The visual output optionally includes graphics, text, icons, video, and any combination thereof (collectively termed “graphics”). In some embodiments, some or all of the visual output corresponds to user interface objects. As used herein, the term “affordance” refers to a user-interactive graphical user interface object (e.g., a graphical user interface object that is configured to respond to inputs directed toward the graphical user interface object). Examples of user-interactive graphical user interface objects include, without limitation, a button, slider, icon, selectable menu item, switch, hyperlink, or other user interface control.

Touch-sensitive display system 112 has a touch-sensitive surface, sensor or set of sensors that accepts input from the user based on haptic and/or tactile contact. Touch-sensitive display system 112 and display controller 156 (along with any associated modules and/or sets of instructions in memory 102) detect contact (and any movement or breaking of the contact) on touch-sensitive display system 112 and converts the detected contact into interaction with user-interface objects (e.g., one or more soft keys, icons, web pages or images) that are displayed on touch-sensitive display system 112. In some embodiments, a point of contact between touch-sensitive display system 112 and the user corresponds to a finger of the user or a stylus.

Touch-sensitive display system 112 optionally uses LCD (liquid crystal display) technology, LPD (light emitting polymer display) technology, or LED (light emitting diode) technology, although other display technologies are used in other embodiments. Touch-sensitive display system 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch-sensitive display system 112. In some embodiments, projected mutual capacitance sensing technology is used, such as that found in the iPhone®, iPod Touch®, and iPad® from Apple Inc. of Cupertino, California.

Touch-sensitive display system 112 optionally has a video resolution in excess of 100 dpi. In some embodiments, the touch screen video resolution is in excess of 400 dpi (e.g., 500 dpi, 800 dpi, or greater). The user optionally makes contact with touch-sensitive display system 112 using any suitable object or appendage, such as a stylus, a finger, and so forth. In some embodiments, the user interface is designed to work with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad for activating or deactivating particular functions. In some embodiments, the touchpad is a touch-sensitive area of the device that, unlike the touch screen, does not display visual output. The touchpad is, optionally, a touch-sensitive surface that is separate from touch-sensitive display system 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 100 optionally also includes one or more optical sensors 164 (e.g., as part of one or more cameras). FIG. 1A shows an optical sensor coupled with optical sensor controller 158 in I/O subsystem 106. Optical sensor(s) 164 optionally include charge-coupled device (CCD) or complementary metal-oxide semiconductor (CMOS) phototransistors. Optical sensor(s) 164 receive light from the environment, projected through one or more lens, and converts the light to data representing an image. In conjunction with imaging module 143 (also called a camera module), optical sensor(s) 164 optionally capture still images and/or video. In some embodiments, an optical sensor is located on the back of device 100, opposite touch-sensitive display system 112 on the front of the device, so that the touch screen is enabled for use as a viewfinder for still and/or video image acquisition. In some embodiments, another optical sensor is located on the front of the device so that the user's image is obtained (e.g., for selfies, for videoconferencing while the user views the other video conference participants on the touch screen, etc.).

Device 100 optionally also includes one or more contact intensity sensors 165. FIG. 1A shows a contact intensity sensor coupled with intensity sensor controller 159 in I/O subsystem 106. Contact intensity sensor(s) 165 optionally include one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor(s) 165 receive contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch-screen display system 112 which is located on the front of device 100.

Device 100 optionally also includes one or more proximity sensors 166. FIG. 1A shows proximity sensor 166 coupled with peripherals interface 118. Alternately, proximity sensor 166 is coupled with input controller 160 in I/O subsystem 106. In some embodiments, the proximity sensor turns off and disables touch-sensitive display system 112 when the multifunction device is placed near the user's ear (e.g., when the user is making a phone call).

Device 100 optionally also includes one or more tactile output generators 167. FIG. 1A shows a tactile output generator coupled with haptic feedback controller 161 in I/O subsystem 106. In some embodiments, tactile output generator(s) 167 include one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Tactile output generator(s) 167 receive tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch-sensitive display system 112, which is located on the front of device 100.

Device 100 optionally also includes one or more accelerometers 168. FIG. 1A shows accelerometer 168 coupled with peripherals interface 118. Alternately, accelerometer 168 is, optionally, coupled with an input controller 160 in I/O subsystem 106. In some embodiments, information is displayed on the touch-screen display in a portrait view or a landscape view based on an analysis of data received from the one or more accelerometers. Device 100 optionally includes, in addition to accelerometer(s) 168, a magnetometer and a GPS (or GLONASS or other global navigation system) receiver for obtaining information concerning the location and orientation (e.g., portrait or landscape) of device 100.

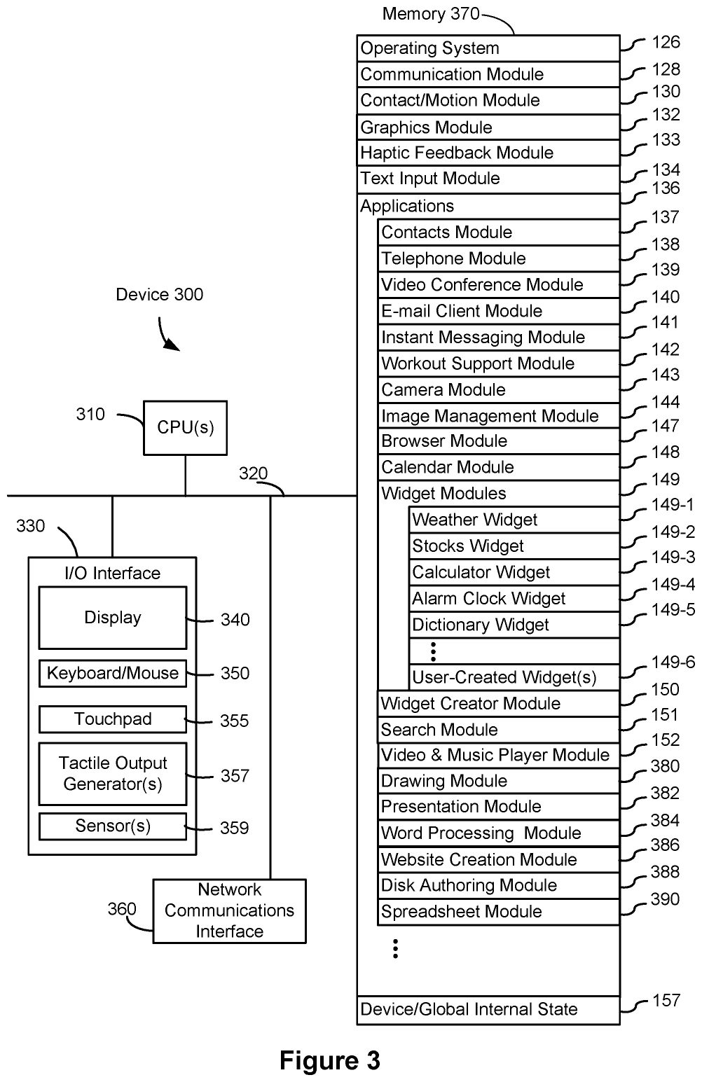

In some embodiments, the software components stored in memory 102 include operating system 126, communication module (or set of instructions) 128, contact/motion module (or set of instructions) 130, graphics module (or set of instructions) 132, haptic feedback module (or set of instructions) 133, text input module (or set of instructions) 134, Global Positioning System (GPS) module (or set of instructions) 135, and applications (or sets of instructions) 136. Furthermore, in some embodiments, memory 102 stores device/global internal state 157, as shown in FIGS. 1A and 3. Device/global internal state 157 includes one or more of: active application state, indicating which applications, if any, are currently active; display state, indicating what applications, views or other information occupy various regions of touch-sensitive display system 112; sensor state, including information obtained from the device's various sensors and other input or control devices 116; and location and/or positional information concerning the device's location and/or attitude.

Operating system 126 (e.g., iOS, Darwin, RTXC, LINUX, UNIX, OS X, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with the 30-pin connector used in some iPhone®, iPod Touch®, and iPad® devices from Apple Inc. of Cupertino, California. In some embodiments, the external port is a Lightning connector that is the same as, or similar to and/or compatible with the Lightning connector used in some iPhone®, iPod Touch®, and iPad® devices from Apple Inc. of Cupertino, California. In some embodiments, the external port is a USB Type-C connector that is the same as, or similar to and/or compatible with the USB Type-C connector used in some electronic devices from Apple Inc. of Cupertino, California.

Contact/motion module 130 optionally detects contact with touch-sensitive display system 112 (in conjunction with display controller 156) and other touch-sensitive devices (e.g., a touchpad or physical click wheel). Contact/motion module 130 includes various software components for performing various operations related to detection of contact (e.g., by a finger or by a stylus), such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts or stylus contacts) or to multiple simultaneous contacts (e.g., “multitouch”/multiple finger contacts). In some embodiments, contact/motion module 130 and display controller 156 detect contact on a touchpad.

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (lift off) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (lift off) event. Similarly, tap, swipe, drag, and other gestures are optionally detected for a stylus by detecting a particular contact pattern for the stylus.

In some embodiments, detecting a finger tap gesture depends on the length of time between detecting the finger-down event and the finger-up event, but is independent of the intensity of the finger contact between detecting the finger-down event and the finger-up event. In some embodiments, a tap gesture is detected in accordance with a determination that the length of time between the finger-down event and the finger-up event is less than a predetermined value (e.g., less than 0.1, 0.2, 0.3, 0.4 or 0.5 seconds), independent of whether the intensity of the finger contact during the tap meets a given intensity threshold (greater than a nominal contact-detection intensity threshold), such as a light press or deep press intensity threshold. Thus, a finger tap gesture can satisfy particular input criteria that do not require that the characteristic intensity of a contact satisfy a given intensity threshold in order for the particular input criteria to be met. For clarity, the finger contact in a tap gesture typically needs to satisfy a nominal contact-detection intensity threshold, below which the contact is not detected, in order for the finger-down event to be detected. A similar analysis applies to detecting a tap gesture by a stylus or other contact. In cases where the device is capable of detecting a finger or stylus contact hovering over a touch sensitive surface, the nominal contact-detection intensity threshold optionally does not correspond to physical contact between the finger or stylus and the touch sensitive surface.

The same concepts apply in an analogous manner to other types of gestures. For example, a swipe gesture, a pinch gesture, a depinch gesture, and/or a long press gesture are optionally detected based on the satisfaction of criteria that are either independent of intensities of contacts included in the gesture, or do not require that contact(s) that perform the gesture reach intensity thresholds in order to be recognized. For example, a swipe gesture is detected based on an amount of movement of one or more contacts; a pinch gesture is detected based on movement of two or more contacts towards each other; a depinch gesture is detected based on movement of two or more contacts away from each other; and a long press gesture is detected based on a duration of the contact on the touch-sensitive surface with less than a threshold amount of movement. As such, the statement that particular gesture recognition criteria do not require that the intensity of the contact(s) meet a respective intensity threshold in order for the particular gesture recognition criteria to be met means that the particular gesture recognition criteria are capable of being satisfied if the contact(s) in the gesture do not reach the respective intensity threshold, and are also capable of being satisfied in circumstances where one or more of the contacts in the gesture do reach or exceed the respective intensity threshold. In some embodiments, a tap gesture is detected based on a determination that the finger-down and finger-up event are detected within a predefined time period, without regard to whether the contact is above or below the respective intensity threshold during the predefined time period, and a swipe gesture is detected based on a determination that the contact movement is greater than a predefined magnitude, even if the contact is above the respective intensity threshold at the end of the contact movement. Even in implementations where detection of a gesture is influenced by the intensity of contacts performing the gesture (e.g., the device detects a long press more quickly when the intensity of the contact is above an intensity threshold or delays detection of a tap input when the intensity of the contact is higher), the detection of those gestures does not require that the contacts reach a particular intensity threshold so long as the criteria for recognizing the gesture can be met in circumstances where the contact does not reach the particular intensity threshold (e.g., even if the amount of time that it takes to recognize the gesture changes).

Contact intensity thresholds, duration thresholds, and movement thresholds are, in some circumstances, combined in a variety of different combinations in order to create heuristics for distinguishing two or more different gestures directed to the same input element or region so that multiple different interactions with the same input element are enabled to provide a richer set of user interactions and responses. The statement that a particular set of gesture recognition criteria do not require that the intensity of the contact(s) meet a respective intensity threshold in order for the particular gesture recognition criteria to be met does not preclude the concurrent evaluation of other intensity-dependent gesture recognition criteria to identify other gestures that do have criteria that are met when a gesture includes a contact with an intensity above the respective intensity threshold. For example, in some circumstances, first gesture recognition criteria for a first gesture—which do not require that the intensity of the contact(s) meet a respective intensity threshold in order for the first gesture recognition criteria to be met—are in competition with second gesture recognition criteria for a second gesture—which are dependent on the contact(s) reaching the respective intensity threshold. In such competitions, the gesture is, optionally, not recognized as meeting the first gesture recognition criteria for the first gesture if the second gesture recognition criteria for the second gesture are met first. For example, if a contact reaches the respective intensity threshold before the contact moves by a predefined amount of movement, a deep press gesture is detected rather than a swipe gesture. Conversely, if the contact moves by the predefined amount of movement before the contact reaches the respective intensity threshold, a swipe gesture is detected rather than a deep press gesture. Even in such circumstances, the first gesture recognition criteria for the first gesture still do not require that the intensity of the contact(s) meet a respective intensity threshold in order for the first gesture recognition criteria to be met because if the contact stayed below the respective intensity threshold until an end of the gesture (e.g., a swipe gesture with a contact that does not increase to an intensity above the respective intensity threshold), the gesture would have been recognized by the first gesture recognition criteria as a swipe gesture. As such, particular gesture recognition criteria that do not require that the intensity of the contact(s) meet a respective intensity threshold in order for the particular gesture recognition criteria to be met will (A) in some circumstances ignore the intensity of the contact with respect to the intensity threshold (e.g. for a tap gesture) and/or (B) in some circumstances still be dependent on the intensity of the contact with respect to the intensity threshold in the sense that the particular gesture recognition criteria (e.g., for a long press gesture) will fail if a competing set of intensity-dependent gesture recognition criteria (e.g., for a deep press gesture) recognize an input as corresponding to an intensity-dependent gesture before the particular gesture recognition criteria recognize a gesture corresponding to the input (e.g., for a long press gesture that is competing with a deep press gesture for recognition).

Graphics module 132 includes various known software components for rendering and displaying graphics on touch-sensitive display system 112 or other display, including components for changing the visual impact (e.g., brightness, transparency, saturation, contrast or other visual property) of graphics that are displayed. As used herein, the term “graphics” includes any object that can be displayed to a user, including without limitation text, web pages, icons (such as user-interface objects including soft keys), digital images, videos, animations and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions (e.g., instructions used by haptic feedback controller 161) to produce tactile outputs using tactile output generator(s) 167 at one or more locations on device 100 in response to user interactions with device 100.

Text input module 134, which is, optionally, a component of graphics module 132, provides soft keyboards for entering text in various applications (e.g., contacts module 137, e-mail module 140, IM module 141, browser module 147, and any other application that needs text input).

GPS module 135 determines the location of the device and provides this information for use in various applications (e.g., to telephone module 138 for use in location-based dialing, to camera module 143 as picture/video metadata, and to applications that provide location-based services such as weather widgets, local yellow page widgets, and map/navigation widgets).

Applications 136 optionally include the following modules (or sets of instructions), or a subset or superset thereof:
contacts module 137 (sometimes called an address book or contact list);
telephone module 138;
video conferencing module 139;
e-mail client module 140;
instant messaging (IM) module 141;
workout support module 142;
camera module 143 for still and/or video images;
image management module 144;
browser module 147;
calendar module 148;
widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
widget creator module 150 for making user-created widgets 149-6;
search module 151;
video and music player module 152, which is, optionally, made up of a video player module and a music player module;
notes module 153;
map module 154; and/or
online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch-sensitive display system 112, display controller 156, contact module 130, graphics module 132, and text input module 134, contacts module 137 includes executable instructions to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers and/or e-mail addresses to initiate and/or facilitate communications by telephone module 138, video conference module 139, e-mail module 140, or IM module 141; and so forth.

In conjunction with RF circuitry 108, audio circuitry 110, speaker 111, microphone 113, touch-sensitive display system 112, display controller 156, contact module 130, graphics module 132, and text input module 134, telephone module 138 includes executable instructions to enter a sequence of characters corresponding to a telephone number, access one or more telephone numbers in address book 137, modify a telephone number that has been entered, dial a respective telephone number, conduct a conversation and disconnect or hang up when the conversation is completed. As noted above, the wireless communication optionally uses any of a plurality of communications standards, protocols and technologies.

In conjunction with RF circuitry 108, audio circuitry 110, speaker 111, microphone 113, touch-sensitive display system 112, display controller 156, optical sensor(s) 164, optical sensor controller 158, contact module 130, graphics module 132, text input module 134, contact list 137, and telephone module 138, videoconferencing module 139 includes executable instructions to initiate, conduct, and terminate a video conference between a user and one or more other participants in accordance with user instructions.

In conjunction with RF circuitry 108, touch-sensitive display system 112, display controller 156, contact module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch-sensitive display system 112, display controller 156, contact module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, Apple Push Notification Service (APNs) or IMPS for Internet-based instant messages), to receive instant messages, and to view received instant messages. In some embodiments, transmitted and/or received instant messages optionally include graphics, photos, audio files, video files and/or other attachments as are supported in a MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, APNs, or IMPS).

In conjunction with RF circuitry 108, touch-sensitive display system 112, display controller 156, contact module 130, graphics module 132, text input module 134, GPS module 135, map module 154, and video and music player module 152, workout support module 142 includes executable instructions to create workouts (e.g., with time, distance, and/or calorie burning goals); communicate with workout sensors (in sports devices and smart watches); receive workout sensor data; calibrate sensors used to monitor a workout; select and play music for a workout; and display, store and transmit workout data.

In conjunction with touch-sensitive display system 112, display controller 156, optical sensor(s) 164, optical sensor controller 158, contact module 130, graphics module 132, and image management module 144, camera module 143 includes executable instructions to capture still images or video (including a video stream) and store them into memory 102, modify characteristics of a still image or video, and/or delete a still image or video from memory 102.

In conjunction with touch-sensitive display system 112, display controller 156, contact module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch-sensitive display system 112, display controller 156, contact module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch-sensitive display system 112, display controller 156, contact module 130, graphics module 132, text input module 134, e-mail client module 140, and browser module 147, calendar module 148 includes executable instructions to create, display, modify, and store calendars and data associated with calendars (e.g., calendar entries, to do lists, etc.) in accordance with user instructions.

In conjunction with RF circuitry 108, touch-sensitive display system 112, display controller 156, contact module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 108, touch-sensitive display system 112, display controller 156, contact module 130, graphics module 132, text input module 134, and browser module 147, the widget creator module 150 includes executable instructions to create widgets (e.g., turning a user-specified portion of a web page into a widget).

In conjunction with touch-sensitive display system 112, display controller 156, contact module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch-sensitive display system 112, display controller 156, contact module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present or otherwise play back videos (e.g., on touch-sensitive display system 112, or on an external display connected wirelessly or via external port 124). In some embodiments, device 100 optionally includes the functionality of an MP3 player, such as an iPod (trademark of Apple Inc.).

In conjunction with touch-sensitive display system 112, display controller 156, contact module 130, graphics module 132, and text input module 134, notes module 153 includes executable instructions to create and manage notes, to do lists, and the like in accordance with user instructions.

In conjunction with RF circuitry 108, touch-sensitive display system 112, display controller 156, contact module 130, graphics module 132, text input module 134, GPS module 135, and browser module 147, map module 154 includes executable instructions to receive, display, modify, and store maps and data associated with maps (e.g., driving directions; data on stores and other points of interest at or near a particular location; and other location-based data) in accordance with user instructions.

In conjunction with touch-sensitive display system 112, display controller 156, contact module 130, graphics module 132, audio circuitry 110, speaker 111, RF circuitry 108, text input module 134, e-mail client module 140, and browser module 147, online video module 155 includes executable instructions that allow the user to access, browse, receive (e.g., by streaming and/or download), play back (e.g., on the touch screen 112, or on an external display connected wirelessly or via external port 124), send an e-mail with a link to a particular online video, and otherwise manage online videos in one or more file formats, such as H.264. In some embodiments, instant messaging module 141, rather than e-mail client module 140, is used to send a link to a particular online video.

Each of the above identified modules and applications correspond to a set of executable instructions for performing one or more functions described above and the methods described in this application (e.g., the computer-implemented methods and other information processing methods described herein). These modules (e.g., sets of instructions) need not be implemented as separate software programs, procedures or modules, and thus various subsets of these modules are, optionally, combined or otherwise re-arranged in various embodiments. In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating example components for event handling in accordance with some embodiments. In some embodiments, memory 102 (in FIG. 1A) or 370 (FIG. 3) includes event sorter 170 (e.g., in operating system 126) and a respective application 136-1 (e.g., any of the aforementioned applications 136, 137-155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display system 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display system 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display system 112 or a touch-sensitive surface.

In some embodiments, event monitor 171 sends requests to the peripherals interface 118 at predetermined intervals. In response, peripherals interface 118 transmits event information. In other embodiments, peripheral interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views, when touch-sensitive display system 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver module 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit or a higher level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177 or GUI updater 178 to update the application internal state 192. Alternatively, one or more of the application views 191 includes one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170, and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event 187 include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first lift-off (touch end) for a predetermined phase, a second touch (touch begin) on the displayed object for a predetermined phase, and a second lift-off (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display system 112, and lift-off of the touch (touch end). In some embodiments, the event also includes information for one or more associated event handlers 190.

In some embodiments, event definition 187 includes a definition of an event for a respective user-interface object. In some embodiments, event comparator 184 performs a hit test to determine which user-interface object is associated with a sub-event. For example, in an application view in which three user-interface objects are displayed on touch-sensitive display system 112, when a touch is detected on touch-sensitive display system 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event 187 also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video and music player module 152. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input-devices, not all of which are initiated on touch screens. For example, mouse movement and mouse button presses, optionally coordinated with single or multiple keyboard presses or holds; contact movements such as taps, drags, scrolls, etc., on touch-pads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable multifunction device 100 having a touch screen (e.g., touch-sensitive display system 112, FIG. 1A) in accordance with some embodiments. The touch screen optionally displays one or more graphics within user interface (UI) 200. In these embodiments, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward) and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also includes one or more physical buttons, such as “home” or menu button 204. As described previously, menu button 204 is, optionally, used to navigate to any application 136 in a set of applications that are, optionally executed on device 100. Alternatively, in some embodiments, the menu button is implemented as a soft key in a GUI displayed on the touch-screen display.

In some embodiments, device 100 includes the touch-screen display, menu button 204 (sometimes called home button 204), push button 206 for powering the device on/off and locking the device, volume adjustment button(s) 208, Subscriber Identity Module (SIM) card slot 210, head set jack 212, and docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In some embodiments, device 100 also accepts verbal input for activation or deactivation of some functions through microphone 113. Device 100 also, optionally, includes one or more contact intensity sensors 165 for detecting intensities of contacts on touch-sensitive display system 112 and/or one or more tactile output generators 167 for generating tactile outputs for a user of device 100.

FIG. 3 is a block diagram of an example multifunction device with a display and a touch-sensitive surface in accordance with some embodiments. Device 300 need not be portable. In some embodiments, device 300 is a laptop computer, a desktop computer, a tablet computer, a multimedia player device, a navigation device, an educational device (such as a child's learning toy), a gaming system, or a control device (e.g., a home or industrial controller). Device 300 typically includes one or more processing units (CPU's) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch-screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable multifunction device 100 (FIG. 1A), or a subset thereof. Furthermore, memory 370 optionally stores additional programs, modules, and data structures not present in memory 102 of portable multifunction device 100. For example, memory 370 of device 300 optionally stores drawing module 380, presentation module 382, word processing module 384, website creation module 386, disk authoring module 388, and/or spreadsheet module 390, while memory 102 of portable multifunction device 100 (FIG. 1A) optionally does not store these modules.

Each of the above identified elements in FIG. 3 are, optionally, stored in one or more of the previously mentioned memory devices. Each of the above identified modules corresponds to a set of instructions for performing a function described above. The above identified modules or programs (e.g., sets of instructions) need not be implemented as separate software programs, procedures or modules, and thus various subsets of these modules are, optionally, combined or otherwise re-arranged in various embodiments. In some embodiments, memory 370 optionally stores a subset of the modules and data structures identified above. Furthermore, memory 370 optionally stores additional modules and data structures not described above.

Attention is now directed towards embodiments of user interfaces (“UI”) that are, optionally, implemented on portable multifunction device 100.

FIG. 4A illustrates an example user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) for wireless communication(s), such as cellular and Wi-Fi signals;
Time;
a Bluetooth indicator;
a Battery status indicator;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser”; and
   Icon 422 for video and music player module 152, labeled “Music”; and
Icons for other applications, such as:
   Icon 424 for IM module 141, labeled “Messages”;
   Icon 426 for calendar module 148, labeled “Calendar”;
   Icon 428 for image management module 144, labeled “Photos”;
   Icon 430 for camera module 143, labeled “Camera”;
   Icon 432 for online video module 155, labeled “Online Video”;
   Icon 434 for stocks widget 149-2, labeled “Stocks”;
   Icon 436 for map module 154, labeled “Maps”;
   Icon 438 for weather widget 149-1, labeled “Weather”;
   Icon 440 for alarm clock widget 149-4, labeled “Clock”;
   Icon 442 for workout support module 142, labeled “Workout Support”;
   Icon 444 for notes module 153, labeled “Notes”; and
   Icon 446 for a settings application or module, which provides access to settings for device 100 and its various applications 136.

It should be noted that the icon labels illustrated in FIG. 4A are merely examples. For example, other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an example user interface on a device (e.g., device 300, FIG. 3) with a touch-sensitive surface 451 (e.g., a tablet or touchpad 355, FIG. 3) that is separate from the display 450. Some of the examples that follow will be given with reference to a device that detects inputs on a touch-sensitive surface that is separate from the display, as shown in FIG. 4B. Although some of the examples that follow will be given with reference to inputs on touch screen display 112 (where the touch sensitive surface and the display are combined), in some embodiments, the device detects inputs on a touch-sensitive surface that is separate from the display, as shown in FIG. 4B. In some embodiments, the touch-sensitive surface (e.g., 451 in FIG. 4B) has a primary axis (e.g., 452 in FIG. 4B) that corresponds to a primary axis (e.g., 453 in FIG. 4B) on the display (e.g., 450). In accordance with these embodiments, the device detects contacts (e.g., 460 and 462 in FIG. 4B) with the touch-sensitive surface 451 at locations that correspond to respective locations on the display (e.g., in FIG. 4B, 460 corresponds to 468 and 462 corresponds to 470). In this way, user inputs (e.g., contacts 460 and 462, and movements thereof) detected by the device on the touch-sensitive surface (e.g., 451 in FIG. 4B) are used by the device to manipulate the user interface on the display (e.g., 450 in FIG. 4B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures, etc.), it should be understood that, in some embodiments, one or more of the finger inputs are replaced with input from another input device (e.g., a mouse based input or a stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

As used herein, the term “focus selector” refers to an input element that indicates a current part of a user interface with which a user is interacting. In some implementations that include a cursor or other location marker, the cursor acts as a “focus selector,” so that when an input (e.g., a press input) is detected on a touch-sensitive surface (e.g., touchpad 355 in FIG. 3 or touch-sensitive surface 451 in FIG. 4B) while the cursor is over a particular user interface element (e.g., a button, window, slider or other user interface element), the particular user interface element is adjusted in accordance with the detected input. In some implementations that include a touch-screen display (e.g., touch-sensitive display system 112 in FIG. 1A or the touch screen in FIG. 4A) that enables direct interaction with user interface elements on the touch-screen display, a detected contact on the touch-screen acts as a “focus selector,” so that when an input (e.g., a press input by the contact) is detected on the touch-screen display at a location of a particular user interface element (e.g., a button, window, slider or other user interface element), the particular user interface element is adjusted in accordance with the detected input. In some implementations, focus is moved from one region of a user interface to another region of the user interface without corresponding movement of a cursor or movement of a contact on a touch-screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch-screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

In some embodiments, the response of the device to inputs detected by the device depends on criteria based on the contact intensity during the input. For example, for some “light press” inputs, the intensity of a contact exceeding a first intensity threshold during the input triggers a first response. In some embodiments, the response of the device to inputs detected by the device depends on criteria that include both the contact intensity during the input and time-based criteria. For example, for some “deep press” inputs, the intensity of a contact exceeding a second intensity threshold during the input, greater than the first intensity threshold for a light press, triggers a second response only if a delay time has elapsed between meeting the first intensity threshold and meeting the second intensity threshold. This delay time is typically less than 200 ms (milliseconds) in duration (e.g., 40, 100, or 120 ms, depending on the magnitude of the second intensity threshold, with the delay time increasing as the second intensity threshold increases). This delay time helps to avoid accidental recognition of deep press inputs. As another example, for some “deep press” inputs, there is a reduced-sensitivity time period that occurs after the time at which the first intensity threshold is met. During the reduced-sensitivity time period, the second intensity threshold is increased. This temporary increase in the second intensity threshold also helps to avoid accidental deep press inputs. For other deep press inputs, the response to detection of a deep press input does not depend on time-based criteria.

In some embodiments, one or more of the input intensity thresholds and/or the corresponding outputs vary based on one or more factors, such as user settings, contact motion, input timing, application running, rate at which the intensity is applied, number of concurrent inputs, user history, environmental factors (e.g., ambient noise), focus selector position, and the like. Example factors are described in U.S. patent application Ser. Nos. 14/399,606 and 14/624,296, which are incorporated by reference herein in their entireties.

### User Interfaces and Associated Processes

Attention is now directed towards embodiments of user interfaces (“UI”) and associated processes that may be implemented on an electronic device, such as portable multifunction device 100 or device 300, with a display, a touch-sensitive surface, (optionally) one or more tactile output generators for generating tactile outputs, and (optionally) one or more sensors to detect intensities of contacts with the touch-sensitive surface.

FIGS. 5A-5S illustrate user interfaces associated with a collaborative shared web-browsing session. In some embodiments, interactions occurring at a first device associated with a first user account are updated on a second device associated a second user account. The user interfaces in these figures are used to illustrate the methods described below, including the methods depicted in the flow charts shown in FIGS. 6A-6D. Although some of the following examples reference inputs on a touch-sensitive surface 451 that is separate from the display 450, in some embodiments, the device detects inputs on a touch-screen display (where the touch-sensitive surface and the display are combined), as shown in FIG. 4A.

In a shared environment, where multiple users can collaborate and changes on one device can impact the other, it is important to indicate to the users not making the change, what changes have occurred. These indications help users understand what has changed since they last viewed the shared web-browser group.

FIG. 5A illustrates two electronic devices that are in communication with each other, where the first electronic device 502 is associated with a first user account 504 (e.g., User Account A), and the second electronic device 506 is associated with a second user account 508 (e.g., User Account B). A user account is unique to each user of a device, in other words, a first user account 504 is associated with a first user (person) and the second user account 508 is associated with a second user (a different person).

FIG. 5A shows the first electronic device displaying a first web-browsing user interface 510 and the second electronic device displaying a second web-browser user interface 512. While first web-browsing user interface 510 is associated with personal computer form factor and the second web-browsing user interface 512 is associated with a mobile device (e.g., a cellphone), any combination of devices is conceivable (e.g., two personal computers; two mobile devices; a tablet device and mobile device, a tablet device and a personal computer, etc.).

Displayed within first web-browsing user interface 510 are one or more controls (e.g., share affordance 514, shared web-browsing session (group) icon 516-1, optional or dynamically displayed webpage navigation controls (e.g., dynamically displayed forward, backward, refresh), etc.) for interacting with the first web-browsing user interface 510. The first web-browsing user interface 510 also includes a first tab 518 associated with displayed first webpage 519 (e.g., Website A) and a second tab 520 associated with a non-displayed webpage (e.g., Website B). The first tab 518 and the second tab 520 are associated with a tab group (e.g., a Politics Talk group that is shared with a one or more members (e.g., family members)). In some embodiments, multiple shared tab groups can exist, and can be switched between using the down arrow affordance 522. In some embodiments, there can be one or more shared tab groups and one or more user-specific tab groups from which to select. This tab group selection allows the user to choose whether to work collaboratively or not at any time of their choosing. In some embodiments, when a non-shared tab-group is selected, the shared web-browsing session (group) icon 516-1 is no longer displayed. In other words, shared web-browsing session (group) icon 516-1 is only displayed when a shared web-browsing session (tab group) is selected.

Displayed within the second web-browsing user interface 512 are one or more controls (e.g., share affordance 524-1 (e.g., a button), webpage navigation controls 524-2 that are optionally dynamic, a reading list affordance 524-3 (e.g., a button), and a tab overview affordance 524-4 (e.g., a button)) are displayed for interacting with the second web-browsing user interface 512. The second web-browsing user interface 512 includes a first mobile tab 526 and associated mobile webpage 528 (e.g., Website A), which corresponds to first tab 518 and associated first displayed webpage 519. As will be discussed in detail below, as an example, a change made at associated mobile webpage 528 will be carried to the first webpage 519. Web-browsing user interface 512 also includes an indication 530 that another tab is open (e.g., a second mobile tab (e.g., as indicated by indication 530), which corresponds to the second tab 520 displayed on the first electronic device). The second web-browsing user interface 512 also includes a banner 532 that indicates that the webpage being displayed is part of a shared tab group/shared session (e.g., the “Politics Talk” tab group being shared with “Family” contacts). The second web-browsing user interface 512 also includes shared web-browsing session (group) icon 516-2, further indicating that the associated mobile webpage 528 is part of a shared tab group/shared session.

FIG. 5A also displays an indication for showing that tab is viewing viewed by a user associated with another electronic device. For example, FIG. 5A illustrates a user icon 534 (e.g., an avatar, a profile picture, or an image) associated with the second user account 508 overlaying the first tab 518, which indicates that second electronic device 506 is currently displaying mobile webpage 528 (e.g., Website A), which corresponds to first displayed webpage 519 of the first electronic device 502. Another user icon 536 associated with the first user account 504 overlaying the first mobile tab 526, which indicates that the first electronic device 502 is currently displaying first displayed webpage 519 (e.g., Website A), which corresponds to mobile webpage 528 (e.g., Website A) of the second electronic device 506.

FIG. 5A also shows displaying an indication 538 illustrating what part of the mobile webpage 528 (e.g., Website A) is being displayed by the second electronic device 506 (e.g., indicating where a user of the second electronic device is viewing a webpage). While the indication 538 is shown on the scroll bar to indicate where the webpage is being viewed, it is also possible to display an indication overlaying the webpage to show a cursor location, when applicable. While one indication was shown on one tab, it is conceivable that there may be more than two participants in a shared tab group. In some embodiments, when multiple (e.g., three plus) participants are simultaneously viewing the same webpage, multiple respective indications will overlay the tab indicating that multiple users are viewing the same webpage. Additionally, indications may be shown on multiple tabs, for example, a second user may be viewing website A (e.g., a second device displaying “websiteA.com”) while a third user is viewing website B (e.g., a third device displaying “websiteB.com”).

FIG. 5B illustrates an input 540 at a user interface element 542, titled “Breaking News!”, displayed in the second web-browser user interface 512 of the second electronic device 506. FIG. 5C illustrates that in response to the input 540, a webpage 544B (e.g., WebsiteA1.com) associated with the user interface element 542 is displayed at the second electronic device 506. It is noted that a new tab is not opened in response to selecting the link, however, in some embodiments, the link could open a new webpage. Additionally, in some implementations, prior to displaying webpage 544B and in response to input 540, the second electronic device 506 may provide a notification that a click within website A on the second electronic device 506 changes the display of website A on the first electronic device. Further, in some embodiments, the notification may identify any users of the first electronic device who will be affected (e.g., selecting the link on the second device changes the webpage that is currently being viewed in both the first and second devices). Further, FIG. 5C illustrates that in response to the input 540 (e.g., information sent from the second electronic device 506 to the first electronic device 502), displaying a webpage 544A (e.g., WebsiteA1.com) at the first electronic device, that corresponds to the webpage 544B. In addition, a user interface element 548 (e.g., a blue dot) is displayed on a first tab 518 to indicate that the corresponding tab (e.g., first mobile tab 526) has been interacted with by a user of the second electronic device 506. In other words, an input that causes a change on one device causes a change on another device. In the event that the same tab is not active on both devices, only an indication on the tab would be displayed to indicate that a change associated with the tab.

FIG. 5C also illustrates an input 550 at a user interface element 552, titled “Story #2 Today in . . . ,” displayed in the first web-browsing user interface 510 of the first electronic device 502. FIG. 5D illustrates that in response to the input 550, a webpage 554 (e.g., WebsiteA2.com) associated with the user interface element 552 is displayed at the first electronic device 502. Further, FIG. 5D illustrates that in response to the input 550 (e.g., information sent from the first electronic device 502 to the second electronic device 506), displaying a webpage 556 (e.g., WebsiteA2.com) at the second electronic device 506, that corresponds to the webpage 554. In addition, a user interface element 558 (e.g., a blue dot, or some other visual characteristic) is displayed on a first mobile tab 526 to indicate that the corresponding tab (e.g., first tab 518) has been interacted with by a user of the first electronic device 506.

FIG. 5D also shows a swipe gesture 560 moving from left to right occurring over first mobile tab 526. FIG. 5E illustrates that in response to the swipe gesture 560, a new tab user interface 562 and a corresponding new mobile tab 564 are displayed on the second electronic device 506. New tab user interface 562 includes a shared favorites section 568, that includes favorited webpages (e.g., Webpage A 570-1, Webpage B 570-2, and Webpage C 570-3) that are specific to a tab group (e.g., “Politics Talks Group”). New tab user interface 562 also includes a list of at least some frequently visited webpages (Webpage D 571-1, Webpage E 571-2, and Webpage F 571-3) which can be either frequently visited webpages associated with the tab group, device specific frequently vested webpages, or account specific frequently visited webpages. New tab user interface 562 also includes a list of webpages from multiple devices (e.g., User B's Laptop and User B's Tablet) associated with the same user account. As shown a first subset of webpages (e.g., webpage 572-1, webpage 572-2, and webpage 572-3) are displayed in the new tab user interface 562 and each one of these web pages is a web page that is currently open on user B's laptop. A second subset of webpages (e.g., webpage 572-4, webpage 572-5, and webpage 572-6) are displayed in the new tab user interface 562 and each one of these web pages is a web page that is currently open on user B's tablet. New tab user interface 562 also includes show all buttons 573-1 and 573-2, each associated with displaying additional tabs that are open on User B's Laptop and User B's Tablet, respectively.

FIG. 5E also shows that in response to the swipe gesture 562, a new tab 566 is displayed at the first electronic device. Since the webpage 554 associated with first tab 518 is being displayed, then a new tab user interface associated new tab 566 is not displayed on the first electronic device 502, unless the new tab 566 is selected. There is no automatic tab switching, as it could be frustrating to users to have tabs switched on them without them providing an input to do so. In some implementations, there may be tab switching between tabs in a tab group. If a user is in a shared tab group and another user changes the currently displayed tab from the tab group, the user may be provided a warning that the tab will switch and the other user may be provided with a warning that the first user is viewing the tab that is about to change in the tab group. Both users may have the ability to cancel the tab switching before the currently active tab in the tab group changes.

FIG. 5E shows and input 574 occurring over a tab overview affordance 524-4. FIG. 5F shows that in response to input 574 occurring over a tab overview affordance 524-4, a tab overview user interface 575 is displayed. Tab overview user interface 575 includes a listing of tabs (e.g., first mobile tab 526, second mobile tab 527, and a new tab 576 associated with new tab user interface 562) associated with the tab group (e.g., “Politics Talks Group”). FIG. 5F also shows an input 577 occurring over a user interface element 578 (e.g., an “x” icon) for closing the new tab 576.

FIG. 5G shows that in response to input 577 occurring over a user interface element 578 for closing the new tab 576, the new tab 576 is closed and only first mobile tab 526 and second mobile tab 527 remain in the tab group. FIG. 5G also shows the new tab 566 that was displayed at the first electronic device 502 is also closed. In addition, the first electronic device 502 also displays a notification 579 that informs the user of the first electronic device 502 that new tab 566 has been closed (e.g., “Steve Closed the New Tab”). In some embodiments, the notification 579 identifies which user of the tab group has closed the tab.

FIG. 5G also shows an input 580 (e.g., a short press) occurring over first mobile tab 526. FIG. 5H shows that in response to input 580 occurring over first mobile tab 526, displaying webpage 556 (e.g., WebsiteA2.com) at the second electronic device 506. FIG. 5H again illustrates a user icon 534 (e.g., an avatar, a profile picture, or an image) associated with the second user account 508 overlaying the first tab 518, which indicates that second electronic device 506 is currently displaying webpage 556 (e.g., Website A2), which corresponds to webpage 554 of the first electronic device 502. Another user icon 536 associated with the first user account 504 is shown overlaying the first mobile tab 526, which indicates that the first electronic device 502 is currently displaying webpage 554 (e.g., Website A2), which corresponds to webpage 556 (e.g., Website A2) of the second electronic device 506.

FIG. 5H also illustrates receiving, at the first electronic device, a cursor input 581 occurring over a user interface element 582 (e.g., an “x” button) for closing the first tab 518. FIG. 5I shows that in response to cursor input 581 occurring over the user interface element 582, displaying a notification 583 on the first electronic device 502 for warning the user of the first electronic device that a user of the second electronic device is viewing the first tab 518 (e.g., first mobile tab 526) that was requested to be closed. Notification 583 also includes a first button 584-1 for confirming that the first tab 518 should be closed, and a second button 584-2 for canceling the request to close the first tab 518.

FIG. 5I also shows a cursor input 585 occurring over second button 584-2 at the first electronic device. FIG. 5J shows that in response to cursor input 585 occurring over second button 584-2, the first tab 518 and corresponding first mobile tab 526 are not closed. FIG. 5J also shows mark-up 586-1 being received at the second electronic device 506, and in response to mark up 586-1 being received at the second electronic device 506, the first electronic device 502 also displays the mark-up 586-2 at a corresponding location on webpage 554. In addition, first electronic device 502 also displays an optional identifier 587 next to mark-up 586-2 indicating that a user of the first electronic device made mark-up 586-2.

FIG. 5J shows and input 588 occurring over a tab overview affordance 524-4. FIG. 5K shows that in response to input 588 occurring over a tab overview affordance 524-4, a tab overview user interface 575 is displayed. Tab overview user interface 575 includes a listing of tabs (e.g., first mobile tab 526 and second mobile tab 527) associated with the tab group (e.g., “Politics Talks Group”).

FIG. 5K also shows an input 589 (e.g., a long press) occurring over first mobile tab 526. FIG. 5L shows that in response to input 589, a sub-menu 590 associated with first mobile tab 526 is displayed. Sub menu 590 includes a first button 591-1 for pinning a tab (e.g., placing the tab first in a list of tabs) and a second button 591-2 for reordering the tabs.

FIG. 5L also shows an input 592 occurring over the first button 591-1. FIG. 5M shows that in response to input 592 occurring over the first button 591-1, the first mobile tab 526 is pinned within the tab overview user interface 575. When pinned, the first mobile tab 526 no longer shows an “x” icon for closing the first mobile tab 526, and requires at least one additional input to be able to close the first mobile tab (e.g., unpin the tab, then close the tab). First mobile tab 526, when pinned, also shows an icon 593 visually indicating that the first mobile tab has been pinned. In addition, the first mobile tab, when pinned, is also displayed at the top of the list of tabs. When a tab is pinned, it will move (reorder) to the top of the list of tabs in the tab overview user interface 575.

In addition, in response to input 592 occurring over the first button 591-1, the first tab 518 on the first electronic device 502 also becomes pinned (e.g., as visually indicated by icon 594). First web-browsing user interface 510 associated with the first electronic device 502 also bifurcates the tab row into a pinned tab section 595-1 and an unpinned tab section 595-2. In some embodiments, a line 595-3 is placed between pinned tab section 595-1 and an unpinned tab section 595-2

FIG. 5M also shows cursor input 596 occurring at first tab 518. FIG. 5N shows that in response to cursor input 596, a warning 5016 is displayed informing the user that the tab they are interacting with is a shared tab, and other people in the tab group can see their search and web-browsing history.

FIG. 5N also shows an input 597 occurring at a share affordance 5018 (e.g., similar to 524-1 in FIG. 5A) for sharing the tab group with an additional participant (e.g., a contact). FIG. 5O shows that in response to input 597 occurring at the share affordance 5018, a sharing user interface 598 is displayed. The sharing user interface 598 includes a user interface for selecting a contact to share the tab group with and whether the shared tab group can be modified by the contact (e.g., collaborated with by the contact). The sharing user interface 598 shows a selectable user interface element 599-1 for specifying whether the shared tab group can be modified by the contact. If the user selects to not make the tab group modifiable by the contact, a list of webpages will be sent instead. The sharing user interface 598 also shows a number of contact icons 5002-1 to 5002-4 that can be selected for sending the inviting a contact to the tab group.

FIG. 5O shows an input 5004 occurring at contact icon 5002-1 for sending an invitation to a contact associated with contact icon 5002-1. FIG. 5P shows that in response to the input 5004 occurring at contact icon 5002-1, displaying a messaging user interface 5006 that includes an invitation 5008 to be sent in a body of a message (e.g., a text message, an email message, etc.).

FIG. 5P also shows a cursor input 5010 occurring over shared web-browsing session (group) icon 516. FIG. 5Q shows that in response to cursor input 5010 occurring over shared web browsing session icon 516, displaying group session (tab group) information window 5011, including shared browsing history 5020 associated with the tabs of the tab group. Additionally, controls for enhanced collaboration are also shown, e.g., a button 5012-1 to initiate a group message with participants in the shared web-browsing session, a button 5012-2 to initiate a group audio-only call with participants in the shared web-browsing session, a button 5012-3 to initiate a group audio/video call with participants in the shared web-browsing session, and a button 5014-4 for initiating a screen share.

FIG. 5R-5S illustrates a standardized overlay for accepting or denying cookies on websites when the website prompts a user for a decision. FIG. 5R illustrates an overlay 5016 that prompts the user to either accept (e.g., using button 5018) or deny (e.g., using button 5020) the cookies associated with “WebsiteA.com.” The overlay would appear the same across any other webpage, which provides users with a streamlined user interface, so they can clearly make the same decision each time they visit a webpage asking the user for this information. Normally, users have to interact with different webpages UIs asking the same information, which can lead to inconsistent selections and mistaken choices.

FIG. 5R shows an input 5022 over button 5018 for denying cookies on this webpage. In response to input 5022 occurring over button 5018, the cookies associated with the displayed webpage (e.g., mobile webpage 528) and subsequent webpages related to the same domain (e.g., Website A) are denied. In further response input 5022 over button 5018, FIG. 5S illustrates another prompt 5024 overlaying the webpage 528, where prompt 5024 notifies the user to whether the browser should automatically deny cookies for all other webpages (or similar webpages). In some embodiments, the prompt 5024 notifies the user whether the browser should automatically deny cookies for this domain in the future, instead of a global decision. In some embodiments, in response to either an input over button 5020 or button 5018, the overlay is dismissed and the underlying webpage is shown or resized.

FIGS. 6A-6D are flow charts illustrating a collaborative shared web-browsing method 600, in accordance with some embodiments. Method 600 is performed at a first electronic device (e.g., device 300, FIG. 3; portable multifunction device 100; or FIG. 1A, and first electronic device 502 in FIG. 5A) with a display generation component. In some embodiments, the display generation component is a touch-screen display and the touch-sensitive surface is on or integrated with the display. In some embodiments, the display is separate from the touch-sensitive surface.

In some embodiments, the first electronic device is associated with a first user account (a unique user ID, e.g., such as first user account 504 in FIG. 5A), and is in communication with a second electronic device (e.g., second electronic device 506 in FIG. 5A) associated with a second user account (different from the first user account, e.g., a second unique user ID, such as second user account 508 in FIG. 5A) (602).

Some operations in method 600 are, optionally, combined and/or the order of some operations is, optionally, changed.

As described below, method 600 provides an intuitive way to interact and efficiently collaborate with one or more webpages being shared with different users on different devices. In a collaborative web-browsing experience, as described in method 600, multiple users across multiple devices can interact with the same tab in a group of shared tabs. A change made by one user to a tab in the group of shared tabs will have their change propagated to all other user's and their respective devices. In other words, selecting a link on one device associated with a first user account, will cause the link to be selected on another device associated with a second user account. Contrary to this, user's will no longer be limited to sharing links to webpages in separate applications (e.g., messaging applications) in order to share webpages. For example, when looking for hotel rooms for a trip, there is no need to endlessly send links back and forth between users, via a messaging application, instead a user can search and interact with links in a shared group of tabs in the web-browsing application. These changes allow the user to be more collaborative, while not requiring them to switch between multiple applications to share content. Further, sharing in this manner also makes it so users do not have to scroll through messaging conversations or search through emails to find previously sent links. The method reduces the number, extent, and/or nature of the inputs from a user when collaborating this way, thereby creating a more efficient human-machine interface. For battery-operated electronic devices, enabling a user to collaborate faster and more efficiently conserves power and increases the time between battery charges. The method also improves responsiveness of the user interface, improves the visual feedback provided to the user (e.g., by making the device appear more responsive to user input), and enhances the operability of the device (e.g., by helping the user to provide proper inputs and reducing user mistakes when operating/interacting with the device.

In some embodiments, (while) the first electronic device displays (604), via the display generation component, a web-browser user (associated with a web-browser application running on the first electronic device) interface (e.g., first web-browsing user interface 510 in FIG. 5A) including one or more tabs shared with the second electronic device (or second user account). In some embodiments, each tab of the one or more tabs is associated with a respective webpage (and a start page (including favorites)). For example, FIG. 5A shows a first tab 518 associated with displayed first webpage 519 (e.g., Website A) and a second tab 520 associated with a non-displayed webpage (e.g., Website B).

In some embodiments, the first electronic device receives (606) information (e.g., from the second electronic device) indicating that a tab group comprising one or more tabs (of a tab group e.g., holiday shopping tab group shared with family (e.g., a group of contacts designated as family members) (e.g., a tab group can have a unique identifier, indicating that a subset of tabs are part of a singular group, (e.g., tabs related to a backpacking trip), and multiple distinct and separate tab groups are possible, and those separate tab groups can either be shared amongst multiple user accounts, or kept associated with one user account (e.g., not shared))) has been interacted with (opening or closing tabs) at the second electronic device associated with the second user account. For example, Figure illustrates an input 540 at a user interface element 542 corresponding to a link to a webpage.

In some embodiments, the first electronic device indicates (608) (via a visual indication), that the tab group has been interacted with at the second electronic device. For example, FIG. 5C illustrates that in response to the input 540 (e.g., information sent from the second electronic device 506 to the first electronic device 502), displaying a webpage 544A (e.g., WebsiteA1.com) at the first electronic device).

In some embodiments, in response to receiving the information, displaying a user interface element corresponding to (or indicative of) the interaction at the second electronic device associated with the second user account.

In some embodiments, the first user account and the second user account may each be associated with additional devices (e.g., each user account may be associated with a respective laptop, desktop, phone, tablet, etc.). In other words, any device that is part of the second user account may be referred to as the second device (e.g., a change on any device within the user account, will be seen on all other devices (e.g., devices capable of supporting this feature) associated with the user account. Thus, the information indicating that a tab of the one or more tabs has been interacted with (opening or closing tabs) at the second electronic device associated with the second user account, can cause an indication to be displayed at all devices associated with the first user account, including the first electronic device.

In some embodiments, more than one tab group exists on the first electronic device, and not all of the tab groups are shared with other user accounts. Stated another way, a user can provide an input for switching between a shared tab group and a non-shared tab group.

In some embodiments, the one or more tabs in the tab group have the same order on both the first electronic device and the second electronic device. In some embodiments, the shared tab group has a name that is shared across the first electronic device and the second electronic device. In some embodiments, the first electronic device can initiate a conversation with the second electronic device on a specific webpage (e.g., having a conversation about the shared webpage), or vice versa. In some embodiments, the conversation can occur between a single participant of the tab group (e.g., between a user of the first electronic device and a second electronic device), or all members of the tab group (e.g., between a user of the first electronic device, a user of the second electronic device, a user of a third electronic device, etc.). In some embodiments, the conversation overlays the webpage, but is still part of the web-browser application (e.g., not a dedicated messaging application). In some embodiments, the conversation is in a separate window that does not overlay the webpage, but alters the webpages area. In some embodiments, suggestions to start a conversation can be presented to inspire users to start a conversation with each other. In some embodiments, notes created while viewing a webpages are shared in the group. In some embodiments, notes can be associated with a webpage and can be shared across tab groups. In some embodiments, the background image (e.g., a photo) for a start page is shared across multiple devices. In some embodiments, an icon and/or color can be associated with a tab group.

In some embodiments, the first electronic device detects (610) an interaction with the tab group (e.g., FIG. 5C illustrates an input 550 at a user interface element 552, titled “Story #2 Today in . . . ,” displayed in the first web-browsing user interface 510 of the first electronic device 502). In some embodiments, in response to detecting the interaction with the tab group at the first electronic device, the first electronic device sends additional information to the second electronic device to indicate at the second electronic device that the tab group has been interacted with at the first electronic device. For example, FIG. 5D illustrates that in response to the input 550 (e.g., information sent from the first electronic device 502 to the second electronic device 506), displaying a webpage 556 (e.g., WebsiteA2.com) at the second electronic device 506.

Allowing changes to be made on any device to be shared to users in the shared group allows the users to be more collaborative, while not requiring them to switch between multiple applications to share content. Further, sharing in this manner also makes it so users do not have to scroll through messaging conversations or search through emails to find previously sent links. Thus, providing users with the ability to have updates automatically shared between other participants in the group is convenient for the user and more power efficient than traditional sharing which relies on a separate messaging application.

In some embodiments, interacting with tab group includes a user opening a tab at the second electronic device (612). For example, a new tab has been added to a shared browsing session (e.g., tab group), and this tab can be either a new webpage or a start page. As illustrated by FIG. 5E, which shows a new tab 566 being displayed on the first electronic device 502 in response to a swipe gesture 560 to open a new tab on the second electronic device 506.

Allowing users to open new tabs, and have that tab opened on other users' devices improves collaboration by keeping any new links in a central area, without requiring the user to parse through different applications to find links to new webpages. Providing users with the ability to have new tabs automatically shared between other participants in the group is convenient for the user and more power efficient than traditional sharing which relies on a separate messaging application.

In some embodiments, the interacting with the tab group includes a user closing a tab of the one or more tabs at the second electronic device (614). For example, FIG. 5F also shows an input 577 occurring over a user interface element 578 (e.g., an “x” icon) for closing the new tab 576, and in response to the input 577, FIG. 5G shows the new tab 576 being closed).

Allowing users to close tabs, and have that tab closed on other users' devices automatically improves collaboration by removing no-longer relevant webpages, which declutters user interfaces for users. This also allows users to interact with desired user interface objects quicker and helps to remove the possibility of erroneously selecting an incorrect link from a number of links.

In some embodiments, indicating that a tab of the one or more tabs has been interacted with includes showing (614) that the tab is being viewed by a user associated with the second electronic device. In some embodiments, indicating that the tab has been interacted with includes indicating that the tab is being displayed on a display generation component of the second electronic device associated with the second user account. In some embodiments, indicating that the tab has been interacted with includes indicating that the tab is being viewed by multiple users each associated with a respective electronic device. In some embodiments, in the event that a second user is viewing (e.g., displaying on a display generation component) the tab on multiple devices that are associated with the same user account, only a single indication is displayed. For example, FIG. 5A illustrates a user icon 534 (e.g., an avatar, a profile picture, or an image) associated with the second user account 508 overlaying the first tab 518, which indicates that second electronic device 506 is currently displaying mobile webpage 528 (e.g., Website A), which corresponds to first displayed webpage 519 of the first electronic device 502.

Indicating which tab in a group of tabs is being viewed by each user to see how they are interreacting with a webpage, which provides additional visual feedback that traditional shared links cannot provide. Stated another way, this visual indication provides further context when interacting with shared webpages (e.g., non-verbal communication). This also acts as a way of stopping a user from closing tabs that another user is viewing.

In some embodiments, indicating that the tab is being viewed by the user associated with the second electronic device, includes displaying (618) a user icon for the user associated with the second electronic device (e.g., an emoji, profile picture, user initials, etc.) (on the tab) (e.g., overlaying the tab). For example, FIG. 5A illustrates a user icon 534, which can be an avatar, a profile picture, or an image associated with the second user account 508 overlaying the first tab 518.

Providing a user specific icon that on its own is able to indicate who is viewing which tab, allows users to quickly discern who is viewing a tab by providing additional visual feedback.

In some embodiments, indicating (620) that the tab is being viewed by the user associated with the second electronic device, further includes displaying an indication illustrating where a webpage associated with the tab is being viewed by the user associated with the second electronic device (e.g., displaying an icon next to a cursor illustrating where the second user is viewing the webpage, and/or displaying a marker in a scroll bar indicating where on a webpage the second user is viewing). In some embodiments, indicating that the tab is being viewed by the user associated with the second electronic device, further includes displaying an indication illustrating where a cursor resides (is displayed), on a display generation component of the second electronic device, a webpage associated with the tab. For example, FIG. 5A also shows displaying an indication 538 illustrating what part of the mobile webpage 528 (e.g., Website A) is being displayed by the second electronic device 506.

Allowing a user to see where on a webpage other users of the group are viewing that webpage (e.g., by showing a scroll location or a cursor location associated with each user), provides even further additional visual feedback that allows for better communication (e.g., non-verbal) between collaborators.

In some embodiments, interacting (622) with a tab of the one or more tabs includes, displaying a (text) note associated with the tab received from the second electronic device (e.g., providing markup (e.g., a typed text, a hand-drawn note) to a webpage associated with the tab). For example, FIG. 5J shows mark-up 586-1 being received at the second electronic device 506, and in response to mark up 586-1 being received at the second electronic device 506, the first electronic device 502 also displays the mark-up 586-2 at a corresponding location on webpage 554.

Allowing comments, a note, and/or a reaction (e.g., a thumbs up, a thumbs down, a heart, etc.) on a webpage provides additional visual feedback that simply a sharing a webpage via a link cannot provide. For example, a user can point to a specific location on a webpage that they want to be noticed by other users, or provide a specific comment regarding a certain area of the webpage.

In some embodiments, indicating (624) that a tab of the one or more tabs of the tab group has been interacted with includes displaying a visual indication (on the tab) that indicates a change (e.g., a change can include, but is not limited to another user: scrolling the webpage associated with the tab, selecting a link on the webpage to go to a new webpage, selecting a link on the webpage to open a new tab, refreshing the webpage, zooming in on a webpage, marking-up the webpage, etc.) to a webpage associated with the tab. In some embodiments, the visual indication is a dot icon on the tab (e.g., a blue dot) that indicates a change has been made. In some embodiments, the visual indication also represents a new tab that has been opened by another device, but not yet viewed by the user using the first electronic device (e.g., the webpage associated with the new tab has not been displayed yet). For example, a user interface element 548 (e.g., a blue dot) is displayed on a first tab 518 to indicate that the corresponding tab (e.g., first mobile tab 526) has been interacted with by a user of the second electronic device 506.

In a collaborative environment, it is imperative to identify changes/updates to a webpage since a user's last visit to the webpage, as it is beneficial to the user to see where changes have been made since their last visit. Automatically showing a visual indication to indicate changes/updates to a webpage since a user's last visit, provides additional visual feedback to the user.

In some embodiments, the visual indication is displayed on the tab (626) (e.g., a dot/badge or other visual indication is displayed on the tab to indicate a change to the tab has occurred). As discussed, a user interface element 548 (e.g., a blue dot) is displayed on a first tab 518 to indicate that the corresponding tab (e.g., first mobile tab 526) has been interacted with by a user of the second electronic device 506.

Providing a simple marker (e.g., a dot placed on a tab) to identify which tabs have been interacted with, provides visual feedback that allows users to quickly identify changes without having the user interface cluttered with mark-up identifying changes.

In some embodiments, the first electronic device displays (628) a webpage (associated with one of the one or more tabs) in the web-browser user interface. In some embodiments, the visual indication includes displaying a user interface element (e.g., a banner) overlaying the webpage (e.g., FIG. 5G illustrates that the first electronic device 502 displays a notification 579 that informs the user of the first electronic device 502 that new tab 566 has been closed (e.g., “Steve Closed the New Tab”), which overlays webpage 554).

Providing a visual indication that overlays a displayed webpage is useful when the visual indication cannot be placed on a tab, which provides improved visual feedback. For example, it is beneficial to notify a user when a tab is closed, however, a visual indication cannot be placed on a tab that is no longer there, so a visual indication such as a banner overlaying a webpage is useful in this scenario. Providing this type of visual indication is useful as it can provide additional information to the user (e.g., textual description of changes), and also notifies a user when something is removed from the shared tab group (e.g., a tab is closed).

In some embodiments, the user interface element overlaying the webpage indicates that the tab has been closed (630). For example, FIG. 5G illustrates that the first electronic device 502 displays a notification 579 that informs the user of the first electronic device 502 that new tab 566 has been closed (e.g., “Steve Closed the New Tab”), which overlays webpage 554.

Indicating when a tab is closed in a shared web-browsing environment, provides participants with additional visual feedback that allows them to better discern how other participants have changed the tab group since their last viewing.

In some embodiments, the web-browser user interface includes a user interface element for indicating that the one or more tabs are shared with the second electronic device (632). For example, an icon is displayed in outside of the webpage and outside of the tab, yet within the web-browser user interface. As illustrated, FIG. 5A shows shared web-browsing session (group) icon 516-1 and shared web-browsing session (group) icon 516-2 are displayed in first web-browsing user interface 510 and second web-browsing user interface 512, respectively.

Indicating when a tab group is being shared with one or more users in a tab group, provides a visual feedback to the user that they are in a shared environment. This indication acts as a passive warning to the user, so they don't visit websites not intended for the shared environment.

In some embodiments, interacting with the tab includes a user pinning a tab of the one or more tabs of the tab group. In some embodiments, the first electronic device displays (634), at the first electronic device, a tab as being pinned within the tab group. In some embodiments, a divider (e.g., a dividing line) is displayed between the pinned tab(s) and non-pinned tabs (e.g., pinned tabs are grouped together in one location, whereas non-pinned tabs are grouped in another location). For example, FIGS. 5L and 5M illustrate an interaction of how pinning a tab on the second electronic device causes instruction to be sent to first electronic device for pinning the same tab. In FIG. 5M, first tab 518 includes icon 594 (e.g., a pin icon) to visually indicate that the first tab 518 has been pinned, and first mobile tab 526 also includes an icon 593 to visually indicate that the first mobile tab 526 has been pinned.

Automatically pinning tabs across multiple users' devices in response to a user on one device pining a tab, provides additional visual feedback to other users signifying the importance of certain tabs as opposed to others.

In some embodiments, the first electronic device displays (636) a webpage (associated with one of the one or more tabs) in the web-browser user interface. In some embodiments, the first electronic device receives a request to close a tab of the one or more tabs of the tab group (e.g., an input at a close affordance of a tab of the one or more tabs) (e.g., FIG. 5H also illustrates receiving, at the first electronic device, a cursor input 581 occurring over a user interface element 582 (e.g., an “x” button) for closing the first tab 518). In some embodiments, in accordance with a determination that information indicates that the tab is being interacted with (e.g., being viewed, scrolled, mouse movements, links being selected, comments being written, etc.) at the second electronic device associated with the second user account, the first electronic device displays a user interface element (e.g., a banner or a warning window) overlaying the webpage that indicates that the tab is being interacted with by another device (e.g., the user interface element). In some embodiments, can include two affordances, one for confirming the request to close the tab and another affordance for cancelling the request to close the tab) (e.g., FIG. 5I shows that in response to cursor input 581 occurring over the user interface element 582, displaying a notification 583 on the first electronic device 502 for warning the user of the first electronic device that a user of the second electronic device is viewing (e.g., being displayed) or interacting with the corresponding webpage associated with the first mobile tab 526 (e.g., the tab that was requested to be closed)). In some embodiments, in accordance with a determination that information indicates that the tab is not being interacted (or being displayed) with at the second electronic device associated with the second user account, the first electronic device forgoes displaying the user interface element at the first electronic device.

Automatically displaying a warning when closing a tab another user is viewing, provides additional feedback to the user so they can confirm whether they want to remove a tab someone else is viewing. This automatic warning ensures that tabs are not closed by accident, causing other users to have to reopen tabs and navigate back to webpages they were viewing.

In some embodiments, the first electronic device receives (638) an input (e.g., a tap input, a mouse click, etc.) at an address bar associated with a tab of the one or more tabs of the tab group (e.g., FIG. 5M also shows cursor input 596 occurring at first tab 518). In some embodiments, in response to receiving the input at the address bar, displaying an alert (e.g., beneath the address bar) that the tab is being shared with at least the second electronic device associated with the second user account (e.g., FIG. 5N shows that in response to cursor input 596, a warning 5016 is displayed informing the user that the tab they are interacting with is a shared tab).

Indicating when a tab is being shared with one or more users in a tab group via an alert, provides a visual feedback to the user that they are in a shared environment. This indication acts as a warning to the user, so they don't visit websites not intended for the shared environment.

In some embodiments, the first electronic device receives (640) receives a browsing history (from the second electronic device). In some embodiments, the first electronic device receives a request to see the browsing history (e.g., FIG. 5P also shows a cursor input 5010 occurring over shared web-browsing session (group) icon 516). In some embodiments, in response to the request, the first electronic device displays the browsing history from the second electronic device (and concurrently displaying the browsing history from the first electronic device). In some embodiments, this is a limited browsing history that only corresponds to shared tabs or tabs shared within a shared grouping of tabs. For example, FIG. 5Q shows that in response to cursor input 5010 occurring over shared web browsing session icon 516, displaying group session (tab group) information window 5011, that includes shared browsing history 5020.

Having a shared browsing history available across multiple user accounts and their associated devices, provides users with improved feedback as they are able to determine with high accuracy what changes have been made since they last interacted with the tab group. Additionally, finding previously shared webpages is easier, as users no longer have to search through messaging conversations to find shared links.

In some embodiments, the first electronic device receives a request (642) to share the tab group with a third electronic device associated with a third user account (e.g., FIG. 5O shows an input 5004 occurring at contact icon 5002-1 for sending an invitation to a contact associated with contact icon 5002-1, where the contact associated with contact icon 5002-1 is associated with a third user account, different from the first user account and the second user account). In some embodiments, in response, the first electronic device displays a user interface for sending a message that includes an invitation to the third electronic device associated with the third user account to collaborate in the tab group. For example, FIG. 5P shows that in response to the input 5004 occurring at contact icon 5002-1, a messaging user interface 5006 that includes an invitation 5008 to be sent in a body of a message (e.g., a text message, an email message, etc.) is displayed.

Being able to add additional participants, via sending a message, provides users a simple way of inviting new members to the group and to view previously shared tabs. Such an approach reduces the number of inputs, as the user does not need to individually reshare every link already in the tab group, and instead they just need to share an invite.

In some embodiments, the request to share the tab group includes selecting (644) a user interface element in the web-browser user interface for sharing the tab group. For example, FIG. 5N also shows an input 597 occurring at a share affordance 5018 (e.g., similar to 524-1 in FIG. 5A) for sharing the tab group with an additional participant (e.g., a contact.

Having a simple affordance for initiating the sharing process reduces the number of inputs the user has to make in order to share the tab group with additional members. For example, the user does not need to manually copy internet links to a separate application to send.

In some embodiments, the first electronic device receives (646) a request to add a new tab to the tab group (e.g., FIG. 5D shows a swipe gesture 560 moving from left to right occurring over first mobile tab 526). In response to receiving the request, the first electronic device displays a start page associated with the one or more tabs of the tab group (e.g., FIG. 5E illustrates that in response to the swipe gesture 560, a new tab user interface 562 and a corresponding new mobile tab 564 are displayed on the second electronic device 506), wherein the start page also includes one or more user interface elements corresponding to shared favorited webpages that are specific to the tab group (e.g., New tab user interface 562 includes a shared favorites section 568, that includes favorited webpages (e.g., Webpage A 570-1, Webpage B 570-2, and Webpage C 570-3) that are specific to a tab group (e.g., “Politics Talks Group”)). In some embodiments, the favorited webpages are not shown when a different non-shared tab-group is selected. In some embodiments, when the tab group is deleted the shared favorited webpages that are specific to the tab group are also deleted. In some embodiments, adding a favorited webpage to the tab group, adds the favorited webpage to all user accounts (and their associated devices) that are collaborating with the tab group. Likewise, removing a favorited webpage from the tab group, removes the favorited webpage from all user accounts (and their associated devices) that are collaborating with the tab group.

Automatically favoriting tabs across multiple users' devices in response to a user on one device favoriting a tab, provides additional visual feedback to other users signifying the importance of certain tabs as opposed to others. Having tab group specific favorited tabs also provides users with the ability to find the most relevant tabs faster and with fewer inputs.

In some embodiments, a method of concurrently displaying open tabs across multiple devices logged into the same user account is performed at a first electronic device with a display that is in communication with second electronic device and a third electronic device. In some embodiments, the first electronic device, the second electronic device, and the third electronic device are logged into the same user account. In some embodiments, the first electronic device receives a request to open a new tab in a web-browser application (or receiving a request to launch a web-browser application). In some embodiments, in response to (only) receiving the request, the first electronic device opens a new tab user interface that concurrently displays: a first subset of user interface elements each associated with one or more tabs open on the second electronic device, a second subset of user interface elements each associated with one or more tabs open on the third electronic device, wherein the second subset of one or more tabs is different from the first subset of one or more tabs, and one or more user interface elements associated with favorited webpages associated with the first device.

In some embodiments, prior to concurrently displaying, receiving an input to open a new tab or open a browser to display. In some embodiments, in response to selecting a user interface element associated with the first subset, display all of the open tabs associated with the second electronic device. In some embodiments, in response to selecting a user interface element associated with the first subset, ceasing to display the second subset of open tabs associated with a third electronic device. In some embodiments, the first electronic device receives an input at one of the tabs from the first subset, and in response the first electronic device displays a webpage associated with the tab. In some embodiments, in response to selecting a user interface element associated with the first subset, the first electronic device displays a search function for searching tabs associated with the first device. In some embodiments, the first electronic device displays an affordance for toggling between for searching tabs of the tab groups associated with the first device and all devices associated with the same user account, and in response to selecting the affordance, enabling all devices to be searched (e.g., performing a global search across all linked devices (e.g., first, second, and third devices)). In some embodiments, the first subset includes displaying no more than three (or four) tabs of the first subset of tabs. In some embodiments, the first subset of tabs is greater than the number of tabs open at second electronic device. In some embodiments, the first electronic device, the second electronic device, and the third electronic device are associated with the same user account. In some embodiments, first subset and second subset are displayed on a start page (e.g., as shown in FIG. 5E). In some embodiments, the start page includes, favorited webpages, recently viewed webpages, shared webpages. In some embodiments, first subset and second subset are displayed when a new tab is opened.

In some embodiments, switching tab groups occurs based on a devices selected focus mode (e.g., work, focus, personal, etc.). For example, when the work focus group is selected a tab group shared with coworkers can be displayed by default. In some embodiments, when the focus mode changes while a user is viewing a tab group that is not associated with a focus mode, an alert can be displayed confirming whether to switch to the tab group associated with the new focus mode.

The operations described above with reference to FIGS. 6A-6D are, optionally, implemented by components depicted in FIGS. 1A-1B. For example, described operations are, optionally, implemented by event sorter 170, event recognizer 180, and event handler 190. Event monitor 171 in event sorter 170 detects a contact on touch-sensitive display 112, and event dispatcher module 174 delivers the event information to application 136-1. A respective event recognizer 180 of application 136-1 compares the event information to respective event definitions 186, and determines whether a first contact at a first location on the touch-sensitive surface (or whether rotation of the device) corresponds to a predefined event or sub-event, such as selection of an object on a user interface, or rotation of the device from one orientation to another. When a respective predefined event or sub-event is detected, event recognizer 180 activates an event handler 190 associated with the detection of the event or sub-event. Event handler 190 optionally uses or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

What is claimed is:

1. A shared web-browser method performed at a first electronic device with a display generation component, where the first electronic device is associated with a first user account, and is in communication with a second electronic device associated with a second user account, the method comprising:
displaying, via the display generation component, a web-browser user interface including one or more tabs shared with the second electronic device, wherein each tab of the one or more tabs is associated with a respective webpage:
receiving, at the first electronic device, information indicating that a tab group comprising one or more tabs has been interacted with at the second electronic device associated with the second user account; and
indicating, at the first electronic device, that the tab group has been interacted with at the second electronic device.

2. The method of claim 1, including:
detecting, at the first electronic device, an interaction with the tab group; and
in response to detecting the interaction with the tab group at the first electronic device:
sending additional information to the second electronic device to indicate at the second electronic device that the tab group has been interacted with at the first electronic device.

3. The method of claim 1, wherein interacting with tab group includes a user opening a tab at the second electronic device.

4. The method of claim 1, wherein interacting with the tab group includes a user closing a tab of the one or more tabs at the second electronic device.

5. The method of claim 1, wherein indicating that the tab group has been interacted with at the second electronic device includes indicating that a tab of the one or more tabs is being viewed by a user associated with the second electronic device.

6. The method of claim 5, wherein indicating that the tab is being viewed by the user associated with the second electronic device includes displaying a user icon for the user associated with the second electronic device.

7. The method of claim 6, wherein indicating that the tab is being viewed by the user associated with the second electronic device further includes displaying an indication illustrating where a webpage associated with the tab is being viewed by the user associated with the second electronic device.

8. The method of claim 1, wherein the web-browser user interface includes a user interface element for indicating that the one or more tabs are shared with the second electronic device.

9. The method of claim 1, wherein interacting with the tab group includes a user of the second electronic device pinning a tab of the one or more tabs of the tab group, and the method includes:
displaying, at the first electronic device, a tab as being pinned within the tab group.

10. The method of claim 1, including:
displaying a webpage in the web-browser user interface; and
receiving, at the first electronic device, a request to close a tab of the one or more tabs of the tab group;
in accordance with a determination that information corresponding to the tab indicates that the tab is being interacted with at the second electronic device associated with the second user account, displaying a user interface element, at the first electronic device, overlaying the webpage that indicates that the tab is being interacted with by another device; and
in accordance with a determination that information corresponding to the tab indicates that the tab is not being interacted with at the second electronic device associated with the second user account, forgoing displaying the user interface element at the first electronic device.

11. The method of claim 1, including:
receiving an input at an address bar associated with a tab of the one or more tabs of the tab group; and
in response to receiving the input at the address bar, displaying an alert that the tab is being shared with at least the second electronic device associated with the second user account.

12. The method of claim 1, including:
receiving, at the first electronic device, a browsing history of the second electronic device;
receiving a request to see the browsing history of the second electronic device; and
in response to the request, displaying the browsing history of the second electronic device and concurrently displaying a browsing history of the first electronic device.

13. The method of claim 1, including:
receiving a request to add a new tab to the tab group; and
in response to receiving the request, displaying a start page associated with the one or more tabs of the tab group, wherein the start page also includes one or more user interface elements corresponding to shared favorite webpages that are specific to the tab group.

14. The method of claim 1, wherein indicating that the tab group has been interacted with at the second electronic device includes displaying a note, associated with a tab of the one or more tabs of the tab group, received from the second electronic device.

15. The method of claim 1, wherein indicating that the tab group has been interacted with at the second device includes displaying a visual indication that indicates a change to a webpage associated with a tab of the one or more tabs of the tab group.

16. The method of claim 15, wherein the visual indication is displayed on the tab.

17. The method of claim 15, including:
displaying a webpage in the web-browser user interface;
wherein the visual indication includes displaying a user interface element overlaying the webpage.

18. The method of claim 17, wherein the user interface element overlaying the webpage indicates that the tab has been closed at the second electronic device.

19. The method of claim 1, including:
receiving a request to share the tab group with a third electronic device associated with a third user account; and
in response to the request, displaying at the first electronic device a user interface for sending a message that includes an invitation to the third electronic device associated with the third user account to collaborate in the tab group.

20. The method of claim 19, wherein the request to share the tab group includes selecting a user interface element in the web-browser user interface for sharing the tab group.

21. A first electronic device, comprising:
a display generation component, where the first electronic device is associated with a first user account, and is in communication with a second electronic device associated with a second user account;
one or more processors; and
memory storing one or more programs, wherein the one or more programs are configured to be executed by the one or more processors, the one or more programs including instructions for:
displaying, via the display generation component, a web-browser user interface including one or more tabs shared with the second electronic device, wherein each tab of the one or more tabs is associated with a respective webpage:
receiving, at the first electronic device, information indicating that a tab group comprising one or more tabs has been interacted with at the second electronic device associated with the second user account; and
indicating, at the first electronic device, that the tab group has been interacted with at the second electronic device.

22. A computer readable storage medium storing one or more programs, the one or more programs comprising instructions, which, when executed by a first electronic device with a display generation component, where the first electronic device is associated with a first user account, and is in communication with a second electronic device associated with a second user account, cause the first electronic device to:
display, via the display generation component, a web-browser user interface including one or more tabs shared with the second electronic device, wherein each tab of the one or more tabs is associated with a respective webpage:
receive, at the first electronic device, information indicating that a tab group comprising one or more tabs has been interacted with at the second electronic device associated with the second user account; and
indicate, at the first electronic device, that the tab group has been interacted with at the second electronic device.
